(19) United States
(12) Patent Application Publication
(10) Pub. No.: US 2008/0281014 A1
(43) Pub. Date: Nov. 13, 2008

(54) Nanosubstance-Containing Composition, Process for Producing the Same, and Composite Made With the Same

(75) Inventors: Fumino Momose, Yokohama-shi (JP); Masayuki Toyama, Toyohashi-shi (JP); Haruko Takahashi, Fujisawa-shi (JP); Shinichi Maeda, Tokyo (JP); Takashi Saitoh, Yokohama-shi (JP); Jun Nakauchi, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: MITSUBISHI RAYON CO., LTD., Tokyo (JP)

(21) Appl. No.: 11/662,384

(22) PCT Filed: Sep. 9, 2005
(86) PCT No.: PCT/JP05/16588

§ 371 Date: Mar. 9, 2007

(30) Foreign Application Priority Data
Sep. 9, 2004 (JP) 2004-262339
Jan. 20, 2005 (JP) 2005-012803
May 30, 2005 (JP) 2005-157472

(51) Int. Cl. C08K 3/04; C08K 5/09

(52) U.S. Cl. 522/71; 524/496; 977/742

(57) ABSTRACT

A composition containing a nanosubstance is provided. Since the composition includes a nanosubstance (a), a (meth)acrylate compound (b) including a polar group, and a solvent (c)/polymerizable monomer (i-1), it is capable of being dispersed or solubilized in various solvents such as organic solvents, hydrous organic solvents and in polymerizable monomers without impairing characteristics of the nanosubstance itself wherein the nanosubstance neither separates out nor aggregates during a long-term storage, the composition being excellent in conductivity, film-forming property and moldability and capable of applying to or coating a substrate by a simple method. A coated film or cured film of a composite formed by the composition on at least one surface of the substrate shows high transparency, and the composite is excellent in water resistance, weatherability and hardness.

### TECHNICAL FIELD

The present invention relates to a nanosubstance-containing composition, manufacturing method thereof, composite made by using the composition, and manufacturing method of the composite. More specifically, the present invention relates to a nanosubstance-containing composition including a nanosubstance, a (meth)acrylic polymer, and a solvent or a polymerizable monomer, manufacturing method thereof, composite made by using the composition, and manufacturing method of the composite.

Priority is claimed on Japanese Patent Application Nos. 2004-262339, filed on Sep. 9, 2004, 2005-012803, filed on Jan. 20, 2005, and 2005-157472, filed on May 30, 2005, the contents of which are incorporated herein by reference.

### BACKGROUND ART

Recently, nanotechnology, which deals with a so-called nanosubstance having a size of nanometer degree, has attracted attention from various industrial fields. Materials having excellent function, which are new and have not been realized by conventional techniques, have been developed by combining a nanosubstance with various other materials at the nanometer level. Since nanosubstances, when they are highly dispersed, show properties which are different from those of a bulk state, techniques to be used for dispersing the substances in a composite are essential. However, since a surface state of a nanosubstance is generally unstable, there is a problem in that nanosubstances tend to be aggregated when made into a composite, and function specific to the nanosubstance cannot be obtained.

For instance, although properties and functions of carbon nanotubes have been studied and evaluated since their discovery in 1991 and application thereof has been actively researched and developed, there is still a problem in that carbon nanotubes produced in a tangled state are further aggregated when made into a composite with a resins or a solution, and natural properties thereof cannot be obtained. For this reason, attempts have been made to homogeneously disperse or dissolve carbon nanotubes in a solvent or a resin by physically treating or chemically modifying them. For instance, a method has been proposed in which a monolayer carbon nanotube is cut in short pieces and dispersed by subjecting the monolayer carbon nanotube to an ultrasonic wave treatment in a strong acid (refer to Non-patent document 1). However, steps of the method are complicated since the treatment is carried out in a strong acid, and hence, the method is not appropriate for industrial application, and the degree of dispersion itself is not sufficient.

By paying attention to the fact that both ends of the monolayer carbon nanotube cut in the above-mentioned manner are opened and include an oxygen-containing functional terminal group, such as a carboxylic acid group, a method has been proposed in which a long-chain alkyl group is introduced by reacting it with an amine compound after converting the carboxylic acid group to an acid chloride so as to be solubilized in a solvent (Non-patent document 2). However, since the long-chain alkyl group is introduced to the monolayer carbon nanotube by covalent bonding, problems still remain, such as damage to the graphene sheet structure of the carbon nanotube which affects the properties of the carbon nanotube itself.

As other attempts, a method has been proposed in which, by paying attention to the fact that a pyrene molecule absorbs onto a surface of the carbon nanotube by a strong interaction, a water-soluble monolayer carbon nanotube is prepared by introducing a substituent having an ammonium ion into a pyrene molecule, and subjecting it to an ultrasonic wave treatment with the monolayer carbon nanotube in water so as to be non-covalently absorbed onto the monolayer carbon nanotube (Non-patent document 3), According to this method, although damage to the graphene sheet structure may be prevented due to the non-covalent bonding type chemical modification, there is a problem in that conductivity of the carbon nanotube decreases due to the presence of a non-conductive pyrene compound.

Another method has been proposed in which a dispersion liquid is obtained by dispersing or solubilizing the carbon nanotube in various solvents, such as water and organic solvent, without deteriorating the characteristics of the carbon nanotube, by using a general surfactant or polymer type dispersing agent (Patent documents 1 and 2). Although it is described that the carbon nanotube was stably dispersed in the dispersion liquid in a solution state, there is no description about the dispersion state of the carbon nanotube in a coating film or composite made from the dispersion liquid, and about the application to conductive materials, and the like.

Also, a composition including a carbon nanotube, conductive polymer, and a solvent as well as a composite prepared by using the composition have been proposed (Patent document 3). It is reported that the characters of the carbon nanotube are not impaired in the composition and the composite due to the presence of the conductive polymer, and the carbon nanotube may be dispersed or solubilized in solvent, such as water, organic solvent and hydrous organic solvent, with long-term storage stability. Although a carbon nanotube composition including the conductive polymer has excellent conductivity, film-forming property and moldability, and is capable of being applied to or coated on a substrate by a simple method, it is difficult to apply the composition to a material required to be transparent due to coloring property associated with the conductive polymer used. Also, since the solubility of the conductive polymer to various solvents is low in general, there is a problem in that the solvent that can be used is limited.

### Patent Document 1 WO 2002/016257

### Patent Document 2 Japanese Unexamined Patent Application, First Publication No. 2005-035810

### Patent Document 3 WO 2004/039893

### Non-patent Document 1 R. E. Smalley, et al., Science, 280, 1253 (1998)

### Non-patent Document 2 J. Chen, et al., Science, 282, 95 (1998)

Non-patent Document 3 Nakajima, et al., Chem. Lett., 638 (2002)

### DISCLOSURE OF THE INVENTION

Accordingly, an object of the present invention is to provide a nanosubstance-containing composition and a manufacturing method thereof, which is capable of being dispersed or solubilized in various solvents such as organic solvents, hydrous organic solvents or in polymerizable monomers without impairing characteristics of the nanosubstance itself, wherein the nanosubstance neither separates out nor aggregates during long-term storage, the composition being excellent in conductivity, film formability, and moldability and capable of being applied to or coated on a substrate by a simple method, and to provide a composite including a coated film or cured film made by the composite which shows high transparency, and a manufacturing method thereof, the composite being excellent in water resistance, weather resistance, and hardness.

The inventors of the present invention, after conducting diligent studies to achieve the above object, have found that a specific (meth)acrylic polymer is capable of dispersing and solubilizing nanosubstances, and completed the present invention.

A first aspect of the present invention provides a nanosubstance-containing composition including: a nanosubstance (a); a (methacrylic polymer (b) having a unit derived from a (meth)acrylic monomer expressed by the following formula (I), and a solvent (c),

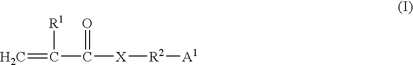

wherein R¹ represents a hydrogen atom or a methyl group, X represents —O—, —NH—, or —N(CH₃)—, R² represents an alkylene group having a number of carbon atoms of 1-24, an arylene group having a number of carbon atoms of 1-24, or an aralkylene group having a number of carbon atoms of 1-24, A¹ represents one selected from the group consisting of a carboxyl group, carboxylate group, sulfonic acid group, sulfonate group, phosphonic acid group, and phosphonate group.

The nanosubstance-containing composition may further include an amine compound (d).

A second aspect of the present invention provides a nanosubstance-containing composition including: a nanosubstance (a); a (meth)acrylic polymer (b) having a unit derived from a (meth)acrylic monomer expressed by the following formula (I), and a polymerizable monomer (i-1),

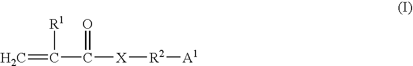

wherein R¹ represents a hydrogen atom or a methyl group, X represents —O—, —NH—, or —N(CH₃)—, R² represents an alkylene group having a number of carbon atoms of 1-24, an arylene group having a number of carbon atoms of 1-24, or an aralkylene group having a number of carbon atoms of 1-24, A¹ represents one selected from the group consisting of a carboxyl group, carboxylate group, sulfonic acid group, sulfonate group, phosphonic acid group, and phosphonate group.

The nanosubstance-containing composition may further include a polymerization initiator (i-2).

Also, the nanosubstance-containing composition may further include an amine compound (d).

A third aspect of the present invention provides a method for preparing the nanosubstance-containing composition of the first aspect, including: mixing a nanosubstance (a), a (meth)acrylic polymer (b), and a solvent (d); and irradiating ultrasonic waves to the mixture, or a method for preparing the nanosubstance-containing composition of the second aspect, including: mixing a nanosubstance (a), a (meth)acrylic polymer (b), and a polymerizable monomer (i-1); and irradiating ultrasonic waves to the mixture.

A fourth aspect of the present invention provides a method for preparing a composite, including: applying the nanosubstance-containing composition of the first aspect or the second aspect to at least one surface of a substrate; and forming a coated film or a cured film by leaving at room temperature, subjecting to a heating process and/or irradiating light.

A fifth aspect of the present invention provides a method for preparing a composite, including: forming a cured film by applying the nanosubstance-containing composition of the second aspect to an inner surface of a mold and curing it; introducing a polymerizable material or a molten resin into the mold and solidifying it to be a substrate; and separating the substrate together with the cured film from the mold.

A sixth aspect of the present invention provides a composite, including: a coated film or a cured film which is formed by applying the nanosubstance-containing composition of the first aspect or the second aspect to at least one surface of a substrate; and leaving at room temperature, subjecting to a heating process and/or irradiating light.

A seventh aspect of the present invention provides a composite produced by: forming a cured film by applying the nanosubstance-containing composition of the second aspect to an inner surface of a mold and curing it; introducing a polymerizable material or a molten resin into the mold and solidifying it to be a substrate; and separating the substrate together with the cured film from the mold.

The composite of the sixth or seventh aspect may have an total light transmittance of 50% or greater.

The composite of the sixth or seventh aspect may be a transparent conductive film, a transparent conductive sheet, or a transparent conductive molded article.

### EFFECT OF THE INVENTION

The nanosubstance-containing composition of the present invention is capable of being dispersed or solubilized in various solvents such as organic solvents, hydrous organic solvents or in polymerizable monomers without impairing characteristics of the nanosubstance itself, wherein the nanosubstance neither separates out nor aggregates during long-term storage. Also, according to the nanosubstance-containing composition of the present invention, it becomes possible to obtain a coating film or cured film having excellent conductivity and film formability independent of the moisture degree in a state of exerting characteristics of the nanosubstance itself, by applying the composition to a substrate. Moreover, the coated film shows high transparency, and is excellent in water resistance, weather resistance, and hardness.

### BEST MODE FOR CARRYING OUT THE INVENTION

Hereinafter, the present invention will be described in detail.

<Nanosubstance (a)>

The nanosubstance used in the present invention is not particularly limited as long as the size of substance is of nanometer degree. Examples of the substance include nanocarbon material, metal particles, metal oxide particles, polymer latex, polymer nanosphere, and the like. Specific examples of the metal particles include Au, Ag, Pd, Pt, Cu, Ni, Co, Fe, Mn, Ru, Rh, Os, Ir, and the like. The term metal oxide particles means a compound expressed by a general formula MxOy, wherein M represents a metal, O represents an oxygen atom, and x and y represent an integer. Examples of the metal oxide include Fe₂O₃, Ag₂O, TiO₂, SiO₂, and the like. Among these nanosubstances, nanocarbon materials are preferably used.

The nanocarbon material (a-1) used in the present invention is not particularly limited as long as it is a carbon material having a size of nanometer degree. Specific examples of the nanocarbon material include fullerene, metal-encapsulating fullerene, onion-shaped fullerene, carbon nanotube, carbon nanohorn, carbon nanofiber, peapod, carbon nanoparticles, and the like. Among these, carbon nanotube is preferably used in practice.

The carbon nanotube (a-2) used in the present invention is not particularly limited, and normal carbon nanotube, i.e., monolayer carbon nanotube, multilayer carbon nanotube in which a plurality of layers are concentrically superimposed, and those in which these carbon nanotubes are in a coiled state, may be utilized. More specifically, the carbon nanotube (a-2) has a structure in which a plurality of cylinders formed by rounding the graphite type carbon atom surface having a thickness of a few atoms level is nested, and examples thereof include a substance having an extremely small outer diameter of nanometer degree. Also, it is possible to utilize carbon nanohorn having a structure in which one end of a carbon nanotube is closed, and a glass-shaped nanocarbon material having an opening at the top.

The method for manufacturing the carbon nanotube (a-2) used in the present invention is not particularly limited. Examples of the method include a catalytic hydrogen reduction of carbon dioxide, an arc discharge method, a laser evaporation method, a CVD method, a vapor growth method, a vapor flow method, a HiPco method in which carbon monoxide is reacted under high temperature and high pressure conditions in the presence of iron catalyst to grow in a vapor phase. Among the carbon nanotube (a-2) obtained by these methods, monolayer carbon nanotube and multilayer carbon nanotube are preferable, and carbon nanotube which is highly purified by various purifying methods, such as a washing method, a centrifugation method, a filtration method, an oxidation method, and chromatographic method is more preferable since various functions of the carbon nanotube may be sufficiently exerted. Also, those which have been ground by a ball type mixer, such as a ball mill, a vibration mill, a sand mill, and a roll mill, or those which have been cut short by chemical or physical treatment may also be utilized as the carbon nanotube (a-2).

<(Meth)acrylic Polymer (b)>

(Meth)acrylic polymer (b) is a polymer which includes a unit derived from a (meth)acrylic monomer expressed by the general formula (I) (hereinafter described as “(meth)acrylic monomer (I)”), and it is preferably a copolymer formed by the (meth)acrylic polymer (I) and an other vinyl monomer which is capable of being polymerized with the (meth)acrylic monomer (I) (hereinafter simply described as “other vinyl monomer”)

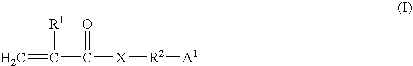

wherein R¹ represents a hydrogen atom or a methyl group, X represents —O—, —NH—, or —N(CH₃)—, R² represents an alkylene group having a number of carbon atoms of 1-24, an arylene group having a number of carbon atoms of 1-24, or an aralkylene group having a number of carbon atoms of 1-24, A¹ represents one selected from the group consisting of a carboxyl group, carboxylate group, sulfonic acid group, sulfonate group, phosphonic acid group, and phosphonate group.

Examples of the (meth)acrylic monomer (I) include a (meth)acrylate derivative having a carboxyl group, a sulfonic acid group, and a phosphonic acid group or salts thereof, a (meth)acryl amide derivative, and the like.

Examples of compounds having a carboxyl group include 2-carboxyethyl acrylate, 3-carboxypropyl acrylate, 2-carboxypropyl acrylate, 4-carboxybutyl acrylate, 3-carboxybutyl acrylate, 2-carboxybutyl acrylate, 6-carboxy n-hexyl acrylate, 5-carboxy n-hexyl acrylate, 4-carboxy n-hexyl acrylate, 3-carboxy n-hexyl acrylate, 2-carboxy n-hexyl acrylate, 4-carboxycyclohexyl acrylate, 4-carboxyphenyl acrylate, ω-carboxy polycaprolactone acrylate, 2-acryloyloxyethyl succinate, 2-acryloyloxyethyl phthalate, 2-carboxy ethyl methacrylate, 3-carboxy propyl methacrylate, 2-carboxy propyl methacrylate, 4-carboxy butyl methacrylate, 3-carboxy butyl methacrylate, 2-carboxy butyl methacrylate, 6-carboxy n-hexyl methacrylate, 5-carboxy n-hexyl methacrylate, 4-carboxy n-hexyl methacrylate, 3-carboxy n-hexyl methacrylate, 2-carboxy n-hexyl methacrylate, 4-carboxy cyclohexyl methacrylate, 4-carboxy phenyl methacrylate, ω-carboxy-polycaprolactone methacrylate, 2-methacryloyloxyethyl succinate, 2-methacryloyloxyethyl phthalate, N-(carboxyethyl)acrylamide, N-(carboxy hydroxymethyl)acrylamide, N-(3-carboxy propyl)acrylamide, N-(2-carboxypropyl)acrylamide, N-(1,1-dimethyl-3-carboxypropyl)acrylamide, N-(4-carboxybutyl)acrylamide, N-(3-carboxybutyl)acrylamide, N-(2-carboxybutyl)acrylamide, N-(6-carboxyhexyl) acrylamide, N-(5-carboxyhexyl)acrylamide, N-(4-carboxyhexyl)acrylamide, N-(3-carboxyhexyl)acrylamide, N-(2-carboxyhexyl)acrylamide, N-methyl N-(carboxyethyl)acrylamide, N-methyl N-(carboxyhydroxymethyl)acrylamide, N-methyl N-3-carboxypropyl)acrylamide, N-methyl N-(2-carboxypropyl)acrylamide, N-methyl N-(1,1-dimethyl3-carboxypropyl)acrylamide, N-methyl N-(4-carboxybutyl)acrylamide, N-methyl N-(3-carboxybutyl)acrylamide, N-methyl N-(2-carboxybutyl)acrylamide, N-methyl N-(6-carboxyhexyl)acrylamide, N-methyl N-(5-carboxyhexyl)acrylamide, N-methyl N-(4-carboxyhexyl)acrylamide, N-methyl N-(3-carboxyhexyl)acrylamide, N-methyl N-(2-carboxyhexyl)acrylamide, N-(carboxyethyl)methacrylamide, N-(carboxyhydroxymethyl)methacrylamide, N-(3-carboxypropyl)methacrylamide, N-(2-carboxypropyl)methacrylamide, N-(1,1-dimethyl3-carboxypropyl)methancrylamide, N-(4-carboxybutyl)methacrylamide, N-(3-carboxybutyl)methacrylamide, N-(2-carboxybutyl)methacrylamide, N-(6-carboxyhexyl)methacrylamide, N-(5-carboxyhexyl)methacrylamide, N-(4-carboxyhexyl)methacrylamide, N-(3-carboxyhexyl)methacrylamide, N-(2-carboxyhexyl)methacrylamide, N-methyl N-(carboxyethyl)methacrylamide, N-methyl N-(carboxyhydroxymethyl)methacrylamide, N-methyl N-(3-carboxypropyl)methacrylamide, N-methyl N-(2-carboxypropyl) methacrylamide, N-methyl N-(1,1-dimethyl 3-carboxypropyl)methacrylamide, N-methyl N-(4-carboxybutyl)methacrylamide, N-methyl N-(3-carboxybutyl)methacrylamide, N-methyl N-(2-carboxybutyl)methacrylamide, N-methyl N-(6-carboxyhexyl) methacrylamide, N-methyl N-(5-carboxyhexyl) methacrylamide, N-methyl N-(4-carboxyhexyl)methacrylamide, N-methyl N-(3-carboxyhexyl)methacrylamide, N-methyl N-(2-carboxyhexyl)methacrylamide, 3-acryloylamino-3-methyl-4-sulfobutyrate, and sodium salts, potassium salt, lithium salt, ammonium salt, tetramethyl ammonium salt, tetraethyl ammonium salt, and benzalkonium salt thereof.

Examples of compounds having sulfonic acid group include 2-sulfoethyl acrylate, 3-sulfopropyl acrylate, 2-sulfopropyl acrylate, 4-sulfobutyl acrylate, 3-sulfobutyl acrylate, 2-sulfobutyl acrylate, 6-sulfo n-hexyl acrylate, 5-sulfo n-hexyl acrylate, 4-sulfo n-hexyl acrylate, 3-sulfo n-hexyl acrylate, 2-sulfo n-hexyl acrylate, 4-sulfocyclohexyl acrylate, 2-sulfoethyl methacrylate, 3-sulfopropyl methacrylate, 2-sulfopropyl metacrylate, 4-sulfobutyl methacrylate, 3-sulfobutyl methacrylate, 2-sulfobutyl methacylate, 6-sulfo n-hexyl methacrylate, 5-sulfo n-hexyl methacrylate, 4-sulfo n-hexyl methacrylate, 3-sulfo n-hexyl methacrylate, 2-sulfo n-hexyl methacrylate, 4-sulfocyclohexyl methacrylate, N-(sulfoethyl)acrylamide, N-sulfohydroxymethyl)acrylamide, N-(3-sulfopropyl)acrylamide, N-(2-sulfopropyl)acrylamide, N-(1,1-dimethyl-3-sulfopropyl)acrylamide, N-(4-sulfobutyl)acrylamide, N-3-sulfobutyl)acrylamide, N-(2-sulfobutyl)acrylamide, N-(6-sulfohexyl)acrylamide, N-(5-sulfohexyl) acrylamide, N-(4-sulfohexyl)acrylamide, N-(3-sulfohexyl)acrylamide, N-(2-sulfohexyl)acrylamide, acrylamide2-methylpropane sulfonate, N-methyl N-(sulfoethyl)acylamide, N-methyl N-sulfohydroxymethyl)acrylamide, N-methyl N-(3-sulfopropyl)acrylamide, N-methyl N-(2-sulfopropyl)acrylamide, N-methyl N-(1,1-dimethyl-3-sulfopropyl)acrylamide, N-methyl N-(4-sulfobutyl)acrylamide, N-methyl N-(3-sulfobutyl)acrylamide, N-methyl N-(2-sulfobutyl)acrylamide, N-methyl N-(6-sulfohexyl)acrylamide, N-methyl N-(5-sulfohexyl)acrylamide, N-methyl N-(4-sulfohexyl)acrylamide, N-methyl N-(3-sulfohexyl)acrylamide, N-methyl N-(2-sulfohexyl)acrylamide, N-sulfoethyl)methacrylamide, N-(sulfohydroxymethyl)methacrylamide, N-3-sulfopropyl)methacrylamide, N-(2-sulfopropyl)methacrylamide, N-1,1-dimethyl-3-sulfopropyl) methacrylamide, N-(4-sulfobutyl)methacrylamide, N-(3-sulfobutyl)methacrylamide, N-(2-sulfobutyl)methacrylamide, N-6-sulfohexyl)methacrylamide, N-(5-sulfohexyl) methacrylamide, N-(4-sulfohexyl)methacrylamide, N-(3-sulfohexyl)methacrylamide, N-(2-sulfohexyl)methacrylamide, methacrylamide2-methylpropanesulfonate, N-methyl N-(sulfoethyl)methacrylamide, N-methyl N-sulfohydroxymethyl)methacrylamide, N-methyl N-(3-sulfopropyl)methacrylamide, N-methyl N-(2-sulfopropyl) methacrylamide, N-methyl N-(1,1-dimethyl3-sulfopropyl)methacrylamide, N-methyl N-(4-sulfobutyl) methacrylamide, N-methyl N-(3-sulfobutyl)methacrylamide, N-methyl N-(2-sulfobutyl) methacrylamide, N-methyl N-(6-sulfohexyl)methacrylamide, N-methyl N-(5-sulfohexyl) methacrylamide, N-methyl N-(4-sulfohexyl)methacrylamide, N-methyl N-(3-sulfohexyl) methacrylamide, N-methyl N-(2-sulfohexyl)methacrylamide, 2-acryloylamino 2-phenyl 1-propanesulfonate, 2-acryloylamino 2-(4-chlorophenyl)-1-propanesulfonate, 2-methacryloylamino 2-phenyl 1-propanesulfonate, 2-methacryloylamino 2-(4-chlorophenyl)-1-propanesulfonate, and sodium salt potassium salt, lithium salt, ammonium salt, tetramethyl ammonium salt, tetraethyl ammonium salt, and benzalkonium salt thereof.

Examples of compounds having a phosphonic acid include 2-phosphono ethyl acrylate, 3-phosphono propyl acrylate, 2-phosphono propyl acrylate, 4-phosphono butyl acrylate, 3-phosphono butyl acrylate, 2-phosphono butyl acrylate, 6-phosphono n-hexyl acrylate, 5-phosphono n-hexyl acrylate, 4-phosphono n-hexyl acrylate, 3-phosphono n-hexyl acrylate, 2-phosphono n-hexyl acrylate, 4-phosphono cyclohexyl acrylate, 4-phosphono phenyl acrylate, 2-phosphono ethyl methacrylate, 3-phosphono propyl methacrylate, 2-phosphono propyl methacrylate, 4-phosphono butyl methacrylate, 3-phosphono butyl methacrylate, 2-phosphono butyl methacrylate, 6-phosphono n-hexyl metacrylate, 5-phosphono n-hexyl methacrylate, 4-phosphono n-hexyl methacrylate, 3-phosphono n-hexyl methacrylate, 2-phosphono n-hexyl methacrylate, 4-phosphono cyclohexyl methacrylate, 4-phosphono phenyl methacrylate, N phosphonoethyl)acrylamide, N-(3-phosphonopropyl)acrylamide, N-(2-phosphonopropyl)acrylamide, N-(1,1-dimethyl 3-phosphonopropyl)acrylamide, N-(4-phosphonobutyl)acrylamide, N-(3-phosphonobutyl)acrylamide, N-(2-phosphonobutyl)acrylamide, N-(6-phosphonohexyl)acrylamide, N-(5-phosphonohexyl)acrylamide, N-(phosphonohexyl)acrylamide, N-3-phosphonohexyl)acrylamide, N-(2-phosphonohexyl)acrylamide, N-methyl N-(phosphonoethyl)acrylamide, N-methyl N-(3-phosphonopropyl)acrylamide, N-methyl N-(2-phosphonopropyl)acrylamide, N-methyl N-(1,1-dimethyl3-phosphonopropyl)acrylamide, N-methyl N-(4-phosphonobutyl)acrylamide, N-methyl N-(3-phosphonobutyl)acrylamide, N-methyl N-(2-phosphonobutyl)acrylamide, N-methyl N-(6-phosphonohexyl)acrylamide, N-methyl N-(5-phosphono hexyl)acrylamide, N-methyl N-(4-phosphonohexyl)acrylamide, N-methyl N-(3-phosphonohexyl)acrylamide, N-methyl N-(2-phosphonohexyl)acrylamide, N-(phosphonoethyl)methacrylamide, N-(3-phosphonopropyl)methacrylamide, N-(2-phosphonopropyl)methacrylamide, N-1,1-dimethyl 3-phosphonopropyl)methacrylamide, N-(4-phosphonobutyl)methacrylamide, N-(3-phosphonobutyl)methacrylamide, N-2-phosphono butyl)methacrylamide, N-6-phosphonohexyl)methacrylamide, N-(5-phosphonohexyl)methacrylamide, N-(4-phosphonohexyl)methacrylamide, N-(3-phosphonohexyl)methacrylamide, N-(2-phosphonohexyl)methacrylamide, N-methyl N-phosphonoethyl)methacrylamide, N-methyl N-(3-phosphonopropyl)methacrylamide, N-methyl N-(2-phosphonopropyl)methacrylamide, N-methyl N-(1,1-dimethyl 3-phosphonopropyl)methacrylamide, N-methyl N-(4-phosphonobutyl)methacrylamide, N-methyl N-(3-phosphono butyl)methacrylamide, N-methyl N-(2-phosphonobutyl) methacrylamide, N-methyl N-(6-phosphonohexyl)methacrylamide, N-methyl N-(5-phosphonohexyl)methacrylamide, N-methyl N-(4-phosphonohexyl)methacrylamide, N-methyl N-(3-phosphonohexyl)methacrylamide, N-methyl N-(2-phosphonohexyl)methacrylamide, and sodium salt, potassium salt, lithium salt, ammonium salt, tetramethyl ammonium salt, tetraethyl ammonium salt, and benzalkonium salt thereof.

It is possible to use (meth)acrylate singularly or in combination of two or more kinds. According to the present invention, the term “(meth)acrylate” means acrylate and/or methacrylate, and the term “(meth)acrylamide” means acrylamide and/or methacrylamide.

Among the above-mentioned (meth)acrylic monomer (I), (meth)acrylic monomers expressed by the following general formula (1) are preferably used.

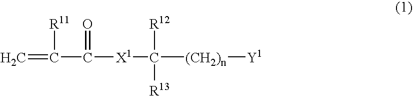

wherein R¹¹ represents a hydrogen atom or a methyl group, R¹² and R¹³ each independently represents a hydrogen atom, a methyl group, or an ethyl group, X¹ represents —O—, —N(H)—, or —N(CH₃)—, Y¹ represents —C(O)OH—, —C(O)O⁻M⁺, —S(O)₂OH, —S(O)₂O⁻M⁺, —P(O)(OH)₂, or —P(O)(OH)O⁻M⁺, n represents an integer of 0 to 3, and M⁺ represents a lithium ion, a sodium ion, a potassium ion, or a group expressed by the following formula (2):

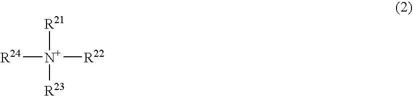

wherein R²¹ to R²⁴ each independently represents a hydrogen atom, an alkyl group having a number of carbon atoms of 1-24, an aryl group having a number of carbon atoms of 1-24, an aralkyl group having a number of carbon atoms of 1-24, a phenyl group, a benzyl group, —R²⁵OH, —(O)NH₂, or —NH₂, and R²⁵ represents an alkylene group having a number of carbon atoms of 1-24, an arylene group having a number of carbon atoms of 1-24, or an aralkylene group having a number of carbon atoms of 1-24.

Among the monomers expressed by the above formula (1), monomers in which Y¹ is —S(O)₂OH, or —S(O)_{O}⁻M⁺ are particularly preferable. Specific examples thereof include 2-ethylsulfonic acid acrylate, 2-ethylsulfonic acid methacrylate, sodium 2-sulfoethylacrylate, potassium 2-sulfoethyl acrylate, ammonium 2-sulfoethylacrylate, ammonium 2-sulfoethyltetramethyl acrylate, sodium 2-sulfoethylmethacrylate, potassium 2-sulfoethylmethacrylate, ammonium 2-sulfoethylmethacrylate, ammonium 2-sulfoethylmethacrylate, sodium 2-sulfopropylmethacrylate, potassium 2-sulfopropylmethacrylate, ammonium 2-sulfopropylmethacrylate, ammonium 2-sulfopropyltetramethylmethacrylate, 2-methylpropanesulfonate, sodium 2-methyl propanesulfonate acrylamide, potassium 2-methylpropanesulfonate acrylamide, ammonium 2-methylpropanesulfonateacrylamide, tetramethylammonium 2-methylpropanesulfonate acrylamide, and the like.

The other vinyl monomer is not particularly limited as long as it is a vinyl compound capable of radical polymerization. The other vinyl monomer may be used singularly or in combination of two or more kinds.

Examples of the vinyl monomer include (meth)acrylate expressed by the following formula (3) or salts thereof, (meth)acrylate ester expressed by the following formula (4); aromatic vinyl compounds, such as styrene and α-methylstyrene; and cyanized vinyl compounds, such as acrylonitrile and methacrylonitrile.

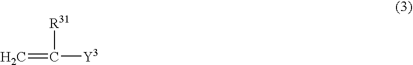

wherein R³¹ represents a hydrogen atom or a methyl group, Y³ represents —C(O)OH, —C(O)O⁻M⁺, and M⁺ represents a lithium ion, a sodium ion, a potassium ion, or an ammonium ion.

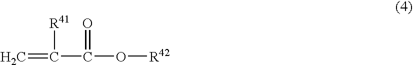

wherein R⁴¹ represents a hydrogen atom or a methyl group, and R⁴² represents an alkyl group having a number of carbon atoms of 1-24.

Among (meth)acrylate expressed by the formula (3) and salts thereof, sodium acrylate, potassium acrylate, sodium methacrylate, and potassium methacrylate are preferable.

Among (meth)acrylate ester expressed by the formula (4), methylacrylate, N-butylacrylate, methyl methacrylate, and ethyl methacrylate are preferable.

Among the above other vinyl monomer, sodium methacrylate, potassium methacrylate, methyl methacrylate, and ethyl methacrylate are particularly preferable.

(Meth)acrylic polymer (b) may be obtained by polymerizing (meth)acrylic monomer (I) and, if necessary, a monomer mixture including the other vinyl monomer.

The ratio of (meth)acrylic monomer (I) and the other vinyl monomer is preferably 99 to 1% by mass of (meth)acrylic monomer (I) to 1 to 99% by mass of the other vinyl monomer. By using 1% by mass or greater of (meth)acrylic monomer (I), it becomes possible to sufficiently disperse or dissolve the carbon nanotube (a-2) in solvent (c) or polymerizable monomer (i-1). By using 1% by mass or greater of the other vinyl monomer, it becomes possible to increase the solubility of (meth)acrylic monomer (I) in solvent (c) or polymerizable monomer (i-1).

It is preferable to carry out the polymerization of the monomer mixture by using a homogeneous polymerization method. (Meth)acrylic polymer (b) obtained by the homogeneous polymerization method has excellent transparency, and a coated film or a cured film of a nanosubstance-containing composition using thereof has high transparency.

Any solvents capable of dissolving (meth)acrylic monomer (I), the other vinyl monomer, and (meth)acrylic polymer (b) may be used as a polymerization solvent. Examples of the solvent include water, methanol, ethanol, isopropanol, benzene, toluene, xylene, acetone, methylethylketone, dimethoxyethane, tetrahydrofuran, chloroform, carbon tetrachloride, dichloroethylene, ethylacetate, N,N dimethylformamide, N,N-dimethyl acetamide, and dimethylsulfoxide. These solvents may be used singularly or in combination of two or more kinds.

The mass ratio of the monomer mixture to the solvent is preferably between 1:1 and 1:25. If the ratio of solvent is 1 or greater with respect to 1 monomer mixture, the viscosity of polymerization solution does not become too high, and it becomes easy to maintain a uniform polymerization temperature. Also, even when monomer having a low degree of solubility is used, restriction on the concentration of monomer is small and effects on the dispersion rate and polymerization rate of monomer become small. If the ratio of solvent is 25 or less with respect to 1 monomer mixture, it is advantageous in terms of productivity and cost. The ratio of monomer mixture to solvent is preferably 1:2 to 1:20, and more preferably 1:3 to 1:15.

A chain transfer agent may be added when polymerizing the monomer mixture. Any known chain transfer agent may be used. Among these, mercaptan type chain transfer agents, such as alkylmercaptan having a number of carbon atoms of 2 to 20, mercaptonic acid, thiophenol and a mixture thereof are preferable, and mercaptan having a short alkyl chain, such as n-octyl mercaptan and n-dodecyl mercaptan, are particularly preferable.

It is preferable to use a radical polymerization initiator, such as an azo compound, organic peroxide, water-soluble inorganic compound, and redox polymerization initiator when polymerizing a monomeric mixture.

Examples of the azo compound include 2,2′-azobis(isobutyronitrile), 2,2′-azo bis(2,4-dimethyl valeronitrile), 2,2′-azobis(isolactic acid)dimethyl, 4,4′-azo bis(4-cyanovaleric acid), 2,2′-azobis(2-amidinopropane) dihydrochloride, 2,2′-azo bis{2-methyl N-[2-(1-hydroxybutyl)]-propione amide, and the like.

Examples of the organic peroxide include benzoyl peroxide, lauroyl peroxide, and the like.

Examples of the water-soluble inorganic compound include persulfate, perborate, percarbonate, and the like.

Examples of the redox polymerization initiator include combinations of the above-mentioned water-soluble inorganic compound with a water-soluble reducing agent, combinations of hydrogen peroxide or hydroperoxide with a reducing agent.

The amount of the radical polymerization initiator is preferably 0.005 to 5 parts by mass with respect to 100 parts by mass of monomer mixture.

<Solvent (c)>

Solvent (c) is not particularly limited as long as (meth)acrylic polymer (b) is dissolved therein, and the nanosubstance is dispersed or dissolved. Examples of thereof include water, organic solvents, and water-containing organic solvent, such as methanol, ethanol, isopropanol, benzene, toluene, xylene, acetone, methylethylketone, dimethoxyethane, tetrahydrofuran, chloroform, carbon tetrachloride, dichloroethylene, ethylacetate, N,N-dimethylformamide, N,N-dimethyl acetamide, and dimethylsulfoxide. These solvents may be used singularly or in combination of two or more kinds.

<Polymerizable Monomer (i-1)>

Polymerizable monomer (i-1) is not particularly limited as long as it dissolves (meth)acrylic polymer (b) and disperses or dissolves the nanosubstance (a) by the action of the (meth)acrylic polymer (b).

Examples of polymerizable monomer (i-1) include (meth)acrylate, (meth)acrylate ester, (meth)acrylic compound having two or more polymerizable groups. Styrene, methylstrene, bromostyrene, vinyltoluene, divinylbenzene, vinyl acetate, N-vinylcaprolactam, and N-vinylpyrrolidone. Among these, (meth)acrylic acid, (meth)acylate ester, and (meth)acrylic compound having two or more polymerizable groups are preferable from the viewpoint of transparency, impact resistance, scratch resistance, and readiness of molding of a curable resin composition.

Examples of (meth)acrylate ester include methyl (meth)acrylate, ethyl (meth)acrylate, propyl (meth)acrylate, isopropyl (meth)acrylate, n-butyl (meth)acrylate, i-butyl (meth)acrylate, t-butyl (meth)acrylate, n-hexyl (meth)acrylate, cyclohexyl (meth)acrylate, lauryl (meth)acrylate, tridecyl (meth)acrylate, stearyl (meth)acrylate, 2-ethylhexyl (meth)acrylate, phenyl (meth)acylate, benzyl(meth)acrylate, isobornyl (meth)acrylate, glycidyl(meth)acrylate, tetrahydrofurfuryl (meth)acrylate, dimethylaminoethyl (meth)acrylate, diethylaminoethyl (meth)acrylate, ethyl trimethyl (meth)acrylate ammonium chloride, 2-hydroxyethyl (meth)acrylate, hydroxypropyl (meth)acrylate, methoxyethyl (meth)acrylate, ethoxyethyl (meth)acrylate, 1,4-butane (meth)acrylate diol, and the like.

Examples of (meth)acrylic compounds having two or more polymerizable groups include (i) ester compounds obtained by reacting 1 mole of polyhydric alcohol with two moles or more of (meth)acrylic acid or derivatives thereof; (ii) linear ester compounds having two or more of (meth)acryloyloxy groups within one molecule obtained by the reaction of polyhydric alcohol, polyhydric carboxylic acid or anhydride thereof, and (meth)acrylic acid or derivatives thereof; (iii) urethane (meth)acylate; (iv) poly[(meth)acryloyloxyethyl]isocyanurate; (v) epoxypolyacrylate; (vi) urethane polyacrylate; and the like.

Examples of the ester compounds of (i) above include di(meth)acrylate, 1,4-butanediol di(meth)acrylate, 1,6-hexanediol di(meth)acrylate, 1,9-nonanediol di(meth)acrylate, trimethylolpropane tri(meth)acrylate, trimethylolethane tri(meth)acrylate, pentaerytritol tri(meth)acrylate, pentaerythritol tetra(meth)acrylate, glycerin tri(meth)acrylate, dipentaerythritol tri(meth)acrylate, dipentaerythritol tetra(meth)acrylate, dipentaerythritol penta(meth)acrylate, dipentaerythritol tetra(meth)acrylate, tripentaerythritol tetra(meth)acrylate, tripentaerythritol penta(meth)acrylate, tripentaerythritol hexa(meth)acrylate, and tripentaerythritol hepta(meth)acrylate of polyethylene glycol.

In the ester compounds of (ii) above, preferable combinations of polyhydric carboxylic acid or anhydride thereof/polyhydric alcohol/(meth) acrylic acid include malonic acid/trimethylolethane/(meth)acrylic acid, malonic acid/trimethylolpropane/(meth)acrylic acid, malonic acid/glycerin(meth)acrylic acid, malonic acid pentaerythritol/(meth)acrylic acid, succinic acid/trimethylolethane/(meth)acrylic acid, succinic acid/trimethylolpropane/(meth)acrylic acid, succinic acid/glycerin/(meth)acrylic acid, succinic acid/pentaerythritol/(meth)acrylic acid, adipic acid/trimethylolethane/(meth)acrylic acid, adipic acid/trimethylolpropane/(meth)acrylic acid, adipic acid/glycerin/(meth)acrylic acid, adipic acid/pentaerythritol/(meth)acrylic acid, glutaric acid/trimethylolethane/(meth)acrylic acid, glutaric acid/trimethylol propane/(meth)acrylic acid, glutaric acid/glycerin/(meth)acrylic acid, glutaric acid/pentaerythritol/(meth)acrylic acid, sebacic acid/trimethylolethane/(meth)acrylic acid, sebacic acid/trimethylolpropane(meth)acrylic acid, sebacic acid/glycerin/(meth)acrylic acid, sebacic acid/pentaerythritol/(meth)acrylic acid, fumaric acid/trimethylolethane/(meth)acrylic acid, fumaric acid/trimethylolpropane/(meth)acrylic acid, fumaric acid/glycerin/(meth)acrylic acid, fumaric acid/pentaerythritol/(meth)acrylic acid, itaconic acid/trimethylolethane/(meth)acrylic acid, itaconic acid/trimethylolpropane/(meth)acrylic acid, itaconic acid/glycerin/(meth)acrylic acid, itaconic acid/pentaerythritol/(meth)acrylic acid, maleic anhydride/trimethylolethane/(meth)acrylic acid, maleic anhydride/trimethylolpropane/(meth)acrylic acid, maleic anhydride/glycerin/(meth)acrylic acid, and maleic anhydride/pentaerythritol/(meth)acrylic acid.

Urethane (meth)acrylate of (iii) above may be obtained by reacting 1 mole of polyisocyanate with 3 mole or more of acrylic monomer having activated hydrogen.

Examples of polyisocyanate include those obtained by trimerizing hexamethylene diisocyanate, trirendiisocyanate, diphenylmethane diisocyanate, xylene diisocyanate, 4,4′-methylene bis(cyclohexyl isocyanate), isophoronediisocyanate, and trimethyl hexamethylene diisocyanate.

Examples of acrylic monomer having activated hydrogen include 2-hydroxyethyl (meth)acrylate, 2-hydroxypropyl (meth)acrylate, 2-hydroxy-3-methoxypropyl (meth)acrylate, N-methylol (meth)acrylamide N-hydroxy (meth)acrylamide, 1,2,3-propane triol-1,3-di(meth)acrylate, and 3-acryloyloxy-2-hydroxypropyl (meth)acrylate.

Examples of poly[(meth)acryloyloxyethyl] isocyanurate of (iv) above include di- or tri(meth)acrylate of tris(2-hydroxyethyl)isocyanuric acid.

It is possible to use polymerizable monomer (i-1) singularly or in combination of two or more.

Also, it is possible to use polymerizable monomer (i-1) together with solvent (c) in order to improve solubility of (meth)acrylic polymer (b) or other components and to adjust the viscosity of nanosubstance-containing composition obtained.

<Polymerization Initiator (i-2)>

Depending on the components of the nanosubstance-containing composition prepared by using polymerizable monomer (i-1), it is possible to use photopolymerization initiator (i-3) or heat polymerization initiator (i-1) as the polymerization initiator (i-2).

Examples of the photopolymerization initiator (i-2) include carbonyl compounds such as benzoin, benzoinmethyl ether, benzoinmethyl ether, benzoinisopropyl ether, benzoinisobutyl ether, acetone, butyroin, toluoin, benzyl, benzophenone, p-methoxy benzophenone, 2,2-diethoxyacetophenone, α,α-dimethoxy α-phenylacetophenone, methylphenylglyoxylate, ethylphenylglyoxylate, 4,4′-bis(dimethylamino)benzophenone, and 2-hydroxy 2-methyl-1-phenylpropane-1-one; sulfur compounds, such as tetramethylthiuram monosulfide and tetramethylthiuram disulfide; 2,4,6-trimethylbenzoldiphenyl phosphine oxide, and benzoyldiethoxy phosphine oxide. The photopolymerization initiator may be used singularly or in combination of two or more kinds.

Examples of heat polymerization initiator (d-2) include those including azo compounds or organoperoxides.

Examples of azo compounds include 2,2′-azo bis(isobutyronitrile), 2,2′-azo bis(2,4-dimethyl vareronitrile), 2,2′-azo bis(isolactate)dimethyl, 4,4′-azo bis(4-cyanovalerate), 2,2′-azo bis(2-amidinopropane) 2 hydrochloride, and 2,2′-azo bis[2-methyl N-[2-(1-hydroxybutyl)]-propionamide].

Examples of the organoperoxides include benzoyl peroxide and lauroyl peroxide.

Heat polymerization initiator may be used singularly or in combination of two or more kinds. Also, the polymerization initiator (i-2) may be mixed with a nanosubstance-containing composition including a nanosubstance (a), a (meth)acrylic polymer (b), and polymerizable monomer (i-1) in advance, or it may be mixed therewith just before use, and hence the timing of mixing the polymerization initiator may be arbitrary selected depending on the purpose of use or conditions.

<Amine Compound (d)>

Examples of amine compound (d) include primary amine compounds, secondary amine compounds, tertiary amine compounds, quaternary ammonium compounds, and polymers having units derived from polymerizable amine compounds. Among these, tertiary amine compounds, quaternary ammonium compounds, and polymers having units derived from polymerizable amine compounds are preferable in terms of improving the dispersion of nanosubstance (a) and the long-term storage stability of nanosubstance-containing composition.

Examples of primary to tertiary amine compounds include those expressed by the following formula (5):

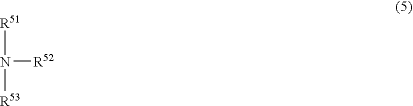

wherein R⁵¹ to R⁵³ each independently represents a hydrogen atom, an alkyl group having a number of carbon atoms of 1-24, an aryl group having a number of carbon atoms of 1-24, an aralkyl group having a number of carbon atoms of 1-24, a phenyl group, a benzyl group, —R⁵⁴OH, —C(O)NH₂, or —NH₂, and R⁵⁴ represents an alkylene group having a number of carbon atoms of 1-24, an arylene group having a number of carbon atoms of 1-24, or an aralkylene group having a number of carbon atoms of 1-24. Note that not all of R⁵¹ to R⁵³ can be a hydrogen atom at the same time.

Examples of the quaternary ammonium compounds include those expressed by the following formula (6).

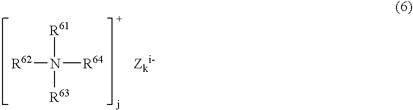

wherein R⁶¹ to R⁶⁴ each independently represents a hydrogen atom, —R⁶⁵OH, an alkyl group having a number of carbon atoms of 1-24, an aryl group having a number of carbon atoms of 1-24, an aralkyl group having a number of carbon atoms of 1-24, a phenyl group, a benzyl group, —C(O)NH₂, or —NH₂, and R⁶⁵ represents an alkylene group having a number of carbon atoms of 1-24, an arylene group having a number of carbon atoms of 1-24, or an aralkylene group having a number of carbon atoms of 1-24, and Zₖⁱ⁻ is at least one anion selected from the 1-3 valence anion group consisting of hydroxide ion, chlorine ion, bromine ion, iodine ion, fluorine ion, nitric acid ion, sulfuric acid ion, hydrogensulfate ion, amidosulfonic acid ion, sulfurous acid ion, phosphinic acid ion, phosphoric acid ion, pyrophosphoric acid ion, tripolyphosphoric acid ion, phosphofluoride ion, perchloric acid ion, thiocyanic acid ion, acetic acid ion, propionic acid ion, methane sulfonic acid ion, p-toluene sulfonic acid ion, valeric acid ion, dodecylbenzene sulfonic acid ion, camphor sulfonation, butyric acid ion, formic acid ion, trimethylacetic acid ion, bromo acetic acid ion, lactic acid ion, citric acid ion, succinic acid ion, oxalic acid ion, tartaric acid ion, fumaric acid ion, maleic acid ion, malonic acid ion, ascorbic acid ion, anisic acid ion, anthranilic acid ion, benzoic acid ion, cinnamic acid ion, phenyl acetic acid ion, phthalic acid ion, aniline sulfonic acid ion, thiocarboxylic acid ion, methylsulfinic acid ion, trifluoroacetic acid ion, and trifluoromethane sulfonic acid ion, i represents valence of ion of Zₖ which is an integer between 1 to 3, and j represents an integer of 1 to 3.

Preferable examples of primary to tertiary amine compounds include benzylamine, tri-n-octylamine, di-n-octylamine, 2-ethylhexylamine, 3-(2-ethylhexyloxy)propylamine, aniline, dimethyl aniline, diethyl aniline, di-n-propyl aniline, and diisopropyl aniline.

Preferable examples of quaternary ammonium ion include halogenated alkyldimethyl benzyl ammonium, such as benzalkonium chloride and trimethylbenzyl ammonium chloride; halogenated alkyldiethyl benzyl ammonium, such as alkyldiethyl benzyl ammonium chloride and bromotriethyl benzyl ammonium; halogenated tetralkyl ammonium, such as trioctylmethyl ammonium chloride; and hydroxy trimethylbenzyl ammonium.

Examples of the polymerizable amine compounds include polymerizable primary to tertiary amine compounds, and polymerizable quaternary ammonium compounds.

Examples of the primary to tertiary amine compounds include polymerizable monomers expressed by the following formula (7):

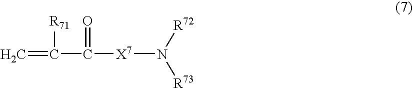

wherein R⁷¹ represents a hydrogen atom or a methyl group, R⁷² and R⁷³ each independently represents a hydrogen atom, an alkyl group having a number of carbon atoms of 1-24, an aryl group having a number of carbon atoms of 1-24, an alkyl group having a number of carbon atoms of 1-24, a phenyl group, a benzyl group, —R⁷⁴OH, —C(O)NH₂, or —NH₂, and R⁷⁴ represents an alkylene group having a number of carbon atoms of 1-24, an arylene group having a number of carbon atoms of 1-24, or an aralkylene group having a number of carbon atoms of 1-24, X⁷ represents —OR⁷⁵⁻; —N(H)R⁷⁶⁻, and R⁷⁵ and R⁷⁶ represent an alkylene group having a number of carbon atoms of 1-24, an arylene group having a number of carbon atoms of 1-24, or an aralkylene group having a number of carbon atoms of 1-24.

Examples of compounds expressed by the formula (7) include dimethylaminomethyl acrylate, dimethylaminoethyl acrylate, dimethylaminopropyl acrylate, dimethylaminobutyl acrylate, dimethylaminohexyl acrylate, dimethylaminomethyl methacrylate, dimethylaminoethyl methacrylate, dimethylaminopropyl methacrylate, dimethylaminobutyl methacylate, dimethylaminohexyl methacylate, diethyl aminomethyl acrylate, diethyl aminoethyl acrylate, diethyl aminopropyl acrylate, diethyl aminobutyl acrylate, diethyl aminohexyl acrylate, diethyl aminomethyl methacrylate, diethyl aminoethyl methacrylate, diethyl aminopropyl methacrylate, diethyl aminobutyl methacrylate, diethyl aminohexyl methacrylate, N-(2-dimethylaminoethyl)acrylamide, N-(3-dimethylaminopropyl)acrylamide; N-(4 dimethylaminobutyl)acrylamide, N-(6-dimethylaminohexyl)acrylamide, N-(2-dimethylaminoethyl)acylamide, N-(3-dimethylaminopropyl)acrylamide, N-4-dimethylaminobutyl)acrylamide, N-(6-dimethylaminohexyl)acrylamide, N-(2-dimethylaminoethyl)methacrylamide N-(3-dimethylaminopropyl)methacrylamide, N-(4-dimethylaminobutyl)methacrylamide, N-(6-dimethylaminohexyl)methacrylamide, N-(2-dimethylaminoethyl)methacrylamide, N-(3-dimethylaminopropyl)methacrylamide, N-(4-dimethylaminobutyl)methacrylamide, and N-(6-dimethylaminohexyl)methacrylamide.

Examples of the polymerizable quaternary ammonium compounds include polymerizable monomers expressed by the following formula (8):

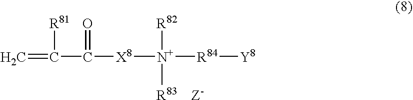

wherein R⁸¹ represents a hydrogen atom or a methyl group, R⁸² and R⁸³ each independently represents a hydrogen atom, an alkyl group having a number of carbon atoms of 1-24, an aryl group having a number of carbon atoms of 1-24, an aralkyl group having a number of carbon atoms of 1-24, a phenyl group, a benzyl group, —R⁸⁵OH, —C(O)NH₂, or —NH₂, and R⁸⁵ represents an alkylene group having a number of carbon atoms of 1-24, an arylene group having a number of carbon atoms of 1-24, or an aralkylene group having a number of carbon atoms of 1-24, X⁸ represents —OR⁸⁶⁻, or —N(H)R⁸⁷—, and R⁸⁶ and R⁸⁷ represent an alkylene group having a number of carbon atoms of 1-24, an arylene group having a number of carbon atoms of 1-24, or an aralkylene group having a number of carbon atoms of 1-24, R⁸⁴ represents an alkylene group having a number of carbon atoms of 1-24, Y⁸ represents a hydrogen atom, an alkyl group having a number of carbon atoms of 1-24, an aryl group having a number of carbon atoms of 1-24, an aralkyl group having a number of carbon atoms of 1-24, a phenyl group, a benzyl group, —R⁸⁸OH, —C(O)NH₂, or —NH₂, R⁸⁸ represents an alkylene group having a number of carbon atoms of 1-24, an arylene group having a number of carbon atoms of 1-24, or an aralkylene group having a number of carbon atoms of 1-24, Z⁻ represents an anion formed by remainder of a quaternizing agent.

Examples of compounds expressed by the formula (8) include those obtained by quaternizing dimethylaminomethyl acrylate, dimethylaminoethyl acrylate, dimethylaminopropyl acrylate, dimethylaminobutyl acrylate, dimethylaminohexyl acrylate, dihydroxyethyl aminoethyl acrylate, dipropyl aminoethyl acrylate, dibutyl aminoethyl acrylate, dimethylaminomethyl methacrylate, dimethylaminoethyl methacrylate, dimethylaminopropyl methacrylate, dimethylaminobutyl methacrylate, dimethylaminohexyl methacrylate, diethyl aminomethyl acrylate, diethyl aminoethyl acrylate, diethyl aminopropyl acrylate, diethyl aminobutyl acrylate, diethyl aminohexyl acrylate, diethyl aminomethyl methacrylate, diethyl aminoethyl methacrylate, diethyl aminopropyl methacrylate, diethyl aminobutyl methacrylate, diethyl aminohexyl methacrylate, dihydroxyethyl aminoethyl metacrylate, dipropyl aminoethyl methacrylate, dibutyl aminoethyl methacrylate, N-(2-dimethylaminoethyl)acrylamide, N-(3-dimethylaminopropyl)acrylamide, N-(4-dimethylaminobutyl)acrylamide, N-(6-dimethylaminohexyl)acrylamide, N-(2-dimethylaminoethyl) acrylamide, N-(3-dimethylaminopropyl)acrylamide, N-(4-dimethylaminobutyl)acrylamide, N-(6-dimethylaminohexyl)acrylamide, N-(2-dimethylamonoethyl)methacrylamide, N-(3-dimethylaminopropyl)methacrylamide, N-(4-dimethylaminobutyl)methacrylamide, N-(6-dimethylaminohexyl)methacrylamide, N-(2-dimethylaminoethyl)methacrylamide, N-(3-dimethylaminopropyl)methacrylamide, N-(4-dimethylaminobutyl)methacrylamide, and N-(6-dimethylaminohexyl)methacrylamide using a quaternizing agent Examples of the quaternizing agents include alkylsulfates, such as dimethylsulfate, diethyl sulfate, and dipropyl sulfate, sulfonate esters, such as methyl p-toluene sulfonate and methyl benzenesulfonate, alkylphosphate such as trimethylphosphite, and various halides of alkylbenzyl chloride, benzyl chloride, alkyl chloride, and alkyl bromide.

Polymers having a unit derived from the polymerizable amine compounds may include units derived from the other vinyl monomers.

Those which can be polymerized with the polymerizable monomers expressed by the formulae (7) and (8) above may be used as the other vinyl monomer, and (meth)acrylic monomers are preferable from the viewpoint of the solubility with solvent (c) or polymerizable monomer (i-1), and the transparency of a coated film or cured film obtained by a nanosubstance-containing composition.

Examples of the polymers having a unit derived from a polymerizable amine compound include copolymers obtained by a polymerizable quaternary ammonium compound expressed by the following formula (9) with (meth)acrylic monomer expressed by the following formula (10):

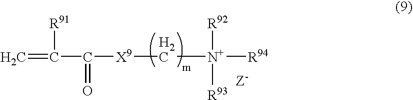

wherein R⁹¹ represents a hydrogen atom or a methyl group, R⁹² to R⁹⁴ each independently represents a hydrogen atom, or an alkyl group having a number of carbon atoms of 1-9 which may include a halogen atom as a substituent, m represents an integer of 1 to 10, Z⁻ represents an anion formed by the remainder of a quaternizing agent, and X⁹ represents —O— or —N(H)—.

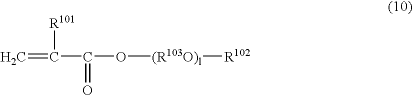

wherein R¹⁰¹ represents a hydrogen atom or a methyl group, R¹⁰² represents a hydrogen atom, an alkyl group having a number of carbon atoms of 1-18, an aryl group having a number of carbon atoms of 1-18, or an aralkyl group having a number of carbon atoms of 1-18, R¹⁰³ represents an alkylene group having a number of carbon atoms of 2-4, and 1 represents an integer of 0 to 500.

Preferable examples of the quaternary ammonium compound expressed by the formula (9) include those obtained by quaternizing dimethylaminoethyl methacrylate, diethylaminoethyl methacrylate, dimethylaminopropyl methacryalate, dimethylaminoethyl acrylate, diethylaminoethyl acrylate, dimethylaminobutyl methacrylate, dihydroethyl aminoethyl methacrylate, dipropylaminoethyl methacrylate, dibutylaminoethyl methacrylate, and the like, by using a quaternizing agent. Examples of the quaternizing agents include alkylsulfates, such as dimethylsulfate, diethyl sulfate, and dipropyl sulfate, sulfonate esters, such as methyl p-toluene sulfonate and methyl benzenesulfonate, alkylphosphate such as trimethylphosphite, and various halides of alkylbenzyl chloride, benzyl chloride, alkyl chloride, and alkyl bromide. Among these, alkylsulfates and sulfonate esters are preferable from the viewpoint of resistance to heat decomposition. Although m in the formula is 1 to 10, m is preferably 2 to 6.

Examples of (meth)acrylate expressed by the formula (10) in which l=0 or 1, include methylmethacrylate, ethyl methacrylate, butyl methacrylate, laurylmethacrylate, ethyl hexyl methacylate, stearylmethacrylate, methylacrylate, ethyl acrylate, benzylmethacrylate, phenyl methacrylate, cyclohexyl methacrylate, and 2-hydroxyethyl methacrylate.

Examples of compounds expressed by the formula (10) in which l=2 to 500, include polyethyleneglycol (4) monomethacrylate, polyethyleneglycol (23) monomethacrylate, polyethylene glycol (300) monomethacrylate, polyethylene glycol (23) monoacrylate, polypropylene glycol (23) monomethacrylate, polybutylene glycol (23) monomethacrylate, polyethylene glycol (23) monomethacrylate monomethyl ether, polyethylene glycol (23) monomethacrylate monobutyl ether, polyethylene glycol (23) monomethacrylate monostearyl ether, polyethylene glycol (23) monomethacrylate monophenyl ether, polyethylene glycol (23) monomethacrylate monobenzyl ether, polyethylene glycol (23) monomethacrylate monooleyl ether (note that the number of polyalkylene glycol units is expressed in the parenthesis).

(Meth)acrylate expressed by the formulae (9) and (10) may be used singularly or in combination of two or more kinds.

<Polymer Compound (e)>

It is possible to improve the adhesion strength to a substrate and strength of a coated film of the nanosubstance-containing composition by using a polymer compound (e). The polymer compound (e) used in the present invention is not particularly limited as long as it is capable of being dissolved or dispersed (i.e., forming emulsion) in the solvent (c) or the polymerizable monomer (i-1) used in the present invention, and not the same substance as the (meth)acrylic polymer (b). Specific examples of the polymer compound include polyvinyl alcohols, such as polyvinyl alcohol, polyvinylformal, polyvinylbutylal; poly(meth)acrylate esters, such as polymethylmethacrylate, polybutyl methacrylate and polymethylacrylate, polymethacrylates, such as polyacrylate, polymethacrylate, polyacrylate ester, polymethacrylate ester, polyacrylamides, such as polyacrylamide, poly(N-t-butyl acrylamide); polyvinylpyrrolidone, polystyrene sulfonate and sodium salts thereof, cellulose, alkyd resin, melamine resin, urea resin phenol resin, epoxy resin, polybutadiene resin, acryl resin, urethane resin, vinyl ester resin, urea resin, polyimide resin, maleic acid resin, polycarbonate resin, vinyl acetate resin, chlorinated polyethylene resin, chlorinated polypropylene resin, styrene resin, acryl/styrene copolymer resin, vinyl acetate/acryl copolymer resin, poly ester resin, styrene/maleic acid copolymer resin, fluoro resin and copolymers thereof. Also, the polymer compound (e) may be a mixture in which two or more of those mentioned above are mixed in an arbitrary ratio.

<Surfactant (f)>

Solubilization or dispersion further accelerates and flatness, coating properties, conductivity, and the like also improve in the nanosubstance-containing composition of the present invention when a surfactant (f) is added thereto. Specific examples of surfactants (f) which can be used in the present invention include anionic surfactants such as alkylsulfonate, alkylbenzene sulfonate, alkylcarboxylate, alkylnaphthalene sulfonate, α-olefin sulfonate, dialkylsulfosuccinate, α-sulfonated aliphatic acid, N-methyl-N-oleyltaurine, petroleum sulfonate, alkylsulfate, sulfated fat and oil, polyoxyethylene alkylether sulfate, polyoxyethylene styrenated phenylether sulfate, alkylphosphate, polyoxyethylene alkylether phosphate, polyoxyethylene alkylphenylether phosphate, naphthalene sulfonate formaldehyde condensates, and salts thereof; cationic surfactants such as primary to tertiary fatty amines, tetralkylammonium, trialkylbenzylammonium, alkylpyridinium salt, 2-alkyl-1-alkyl-1-hydroxyethylimidazolinium, N,N dialkylmorpholinium, polyethylenepolyamine fatty acid amide and salts thereof, urea condensates of polyethylenepolyamine fatty acid amide and salts thereof, and quaternary ammonium salts of urea condensates of polyethylenepolyamine fatty acid amide; amphoteric surfactants such as betaines like N,N-dimethyl-N-alkyl-N-carboxymethyl ammonium betaine, N,N,N-trialkyl-N-sulfoalkylene ammonium betaine, N,N-dialkyl-N,N-bispolyoxyethylene ammonium sulfate ester betaine, and 2-alkyl-carboxymethyl-1-hydroxyethylimidazolinium betaine, and amino carboxylates like N,N-dialkylaminoalkylene carboxylate; nonionic surfactants such as polyoxyethylene alkylether, polyoxyethylene alkylphenyl ether, polyoxyethylene polystyrylphenyl ether, polyoxyethylene-polyoxypropylene glycol, polyoxyethylene-polyoxypropylene alkylether, polyhydric alcohol fatty acid partial esters, polyoxyethylene polyhydric alcohol fatty acid partial esters, polyoxyethylene fatty acid esters, polyglycerin fatty acid esters, polyoxy ethylenated castor oil, fatty acid diethanol amide, polyoxyethylene alkylamine, triethanolamine fatty acid partial esters, and trialkylaminoeoxide; and fluoro surfactants such as fluoroalkylcarboxylic acid, perfluoroalkylcarboxylic acid, perfluoroalkylbenzene sulfonate, and perfluoroalkyl polyoxyethylene ethanol. Alkyl groups preferably have 1 to 24 carbon atoms and 3 to 18 carbon atoms are more preferable. Note that two or more surfactants may be used.

<Silane Coupling Agent (g)>

Furthermore, silane coupling agents can be used concomitantly in the present invention. Water resistance of coating films, which are obtained from the composition containing nanomaterials where a silane coupling agent is used concomitantly, improves considerably. The silane coupling agents which can be used in the present invention are not particularly limited as long as they dissolve in the solvent (c) or polymerizable monomer (i-1) used in the present invention and examples thereof include silane coupling agents represented by the formula (11) below.

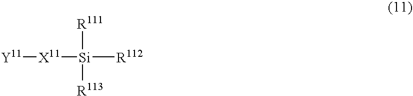

In the formula (11), R¹¹¹ to R¹¹³ each independently represents hydrogen, a linear or branched alkyl group having 1 to 6 carbon atoms, linear or branched alkoxy group having 1 to 6 carbon atoms, amino group, acetyl group, phenyl group, or halogen, X¹¹ is the group represented by the formula (12) below and Y¹¹ represents a hydroxyl group, thiol group, amino group, epoxy group, or epoxycyclohexyl group.

—(CH₂)ₚ— or —(CH₂)_{q}—O—(CH₂)ᵣ— (12)

(In the formula (12), p, q, and r each represents an integer of 1 to 6.)

Examples of silane coupling agents having an epoxy group include γ-glycidyloxypropyl trimethoxysilane, γ-glycidyloxypropyl methyl dimethoxysilane, and γ-glycidyloxypropyl triethoxysilane.

Examples of silane coupling agents having an amino group include γ-aminopropyl triethoxysilane, β-aminoethyl trimethoxysilane, and γ-aminopropoxypropyl trimethoxysilane.

Examples of silane coupling agents having a thiol group include γ-mercaptopropyl trimethoxysilane and β-mercaptoethyl methyl dimethoxysilane.

Examples of silane coupling agents having a hydroxyl group include β-hydroxyethoxyethyl triethoxysilane and γ-hydroxyropyl trimethoxysilane.

Examples of silane coupling agents having an epoxycyclohexyl group include β-(3,4-epoxycyclohexyl)ethyl trimethoxysilane.

<Colloidal Silica (h)>

Furthermore, colloidal silica (h) can be used concomitantly in the present invention. The coated film obtained from the nanosubstance-containing composition where colloidal silica (h) is used concomitantly has considerably improved surface hardness and weather resistance. Although colloidal silica (h) which can be used in the present invention is not particularly limited, those dispersed in organic solvents or in mixed solvents of water and organic solvents are preferably used. Although organic solvents are not particularly limited, examples of those preferably used include, for example, alcohols such as methanol, ethanol, isopropyl alcohol, propyl alcohol, butanol, and pentanol; ketones such as acetone, methylethyl ketone, ethyl isobutyl ketone, and methylisobutyl ketone; ethyleneglycols such as ethyleneglycol, ethyleneglycolmethylether, and ethyleneglycol mono-n-propyl ether; and propyleneglycols such as propyleneglycol, propyleneglycolmethylether, propyleneglycolethyl ether, propyleneglycolbutyl ether, and propyleneglycolpropyl ether. In addition, colloidal silica (h) having a particle diameter of 1 nm to 300 nm is preferable and more preferably 1 nm to 150 nm and even more preferably 1 nm to 50 nm. Surface hardness and weather resistance considerably improve in the resulting coated film while maintaining its transparency when colloidal silica having a particle diameter within this range is used.

### <Nanosubstance-Containing Composition>

As essential components, the nanosubstance-containing composition of the present invention contains a combination of nanosubstance (a), (meth)acrylic polymer (b), and solvent (c), or nanosubstance (a), (meth)acrylic polymer (b), and polymerizable monomer (i-1). Moreover, in the system where a polymerizable monomer (i-1) is used, it is effective to use a polymerization initiator (i-2) concomitantly. Furthermore, the nanosubstance-containing composition of the present invention may contain amine compounds (d), polymer compounds (e), surfactants (f), silane coupling agents g, or colloidal silica (h) when necessary.

The amount of nanosubstance (a) is preferably 0.0001 to 20 pats by mass and more preferably 0.001 to 10 pats by mass relative to 100 pats by mass of solvent (c) or polymerizable monomer (i-1). In the case where the nanosubstance is a carbon nanotube (a-2), conductivity, solubility, or dispersibility thereof is particularly favorable within these composition ranges and even when the amount of nanosubstance (a) increases, there are no further great improvements in terms of performance.

In terms of the amount of (meth)acrylic polymer (b), 0.001 to 50 pats by mass of (meth)acrylic polymer (b), which contains a polar group, are preferable and 0.01 to 30 pats by mass are more preferable relative to 100 pats by mass of solvent (c) or polymerizable monomer (i-1). Conductivity, solubility, or dispersibility is particularly favorable within these ranges and even when the amount of (meth)acrylic polymer (b) increases, there are no further great improvements in terms of performance.

When a polymerization initiator (i-2) is used, its preferable amount is 0.05 to 10 pats by mass relative to 100 pats by mass of polymerizable monomer (i-1) in the case of using a photopolymerization initiator (i-3) as the polymerization initiator (i-2). By setting the amount of photopolymerization initiator (i-3) within this range, the nanosubstance-containing composition, which has been prepared using polymerizable monomer (i-1), cures sufficiently and a highly transparent composite is obtained without causing coloring of a cured film.

When a thermal polymerization initiator (i-4) is used as the polymerization initiator (i-2), the preferable amount thereof is 0.05 to 10 pats by mass relative to 100 pats by mass of polymerizable monomer (i-1). By setting the amount of thermal polymerization initiator (i-4) within this range, the nanosubstance-containing composition, which has been prepared using polymerizable monomer (i-1), cures sufficiently and a highly transparent composite is obtained without causing coloring of a cured film.

The amount of amine compounds (d) is preferably 0.01 to 40 pats by mass and more preferably 0.01 to 20 pats by mass relative to 100 pats by mass of solvent (c) or polymerizable monomer (i-1). Dispersibility and long-term storage stability of nanosubstances such as carbon nanotubes improve when the amount of amine compounds is 0.01 pats by mass or more and reductions in weather resistance, conductivity, and strength of a laminated body, which is obtained when the amount of amine compounds is 40 parts or less, are small resulting in the favorable maintenance of properties thereof.

The amount of polymer compounds (e) is preferably 0.1 to 400 pats by mass and more preferably 0.5 to 300 pats by mass relative to 100 pats by mass of solvent (c) or polymerizable monomer (i-1). When the amount of polymer compounds (e) is 0.1 pats by mass or more, film-formability, moldability, and strength further improve whereas when the amount of polymer compounds (e) is 400 pats by mass or less, reductions in solubility of acrylic polymers or nanosubstances are small and properties thereof (conductivity in the case of carbon nanotubes) are particularly favorably maintained.

The amount of surfactants (f) is preferably 0.0001 to 10 pats by mass and more preferably 0.01 to 5 pats by mass relative to 100 pats by mass of solvent (c) or polymerizable monomer (i-1). Solubility or dispersibility and long-term storage stability of nanosubstances are particularly favorable within these ranges and even when the amount of surfactants (f) increases, there are no further great improvements in terms of performance.

The amount of silane coupling agents (g) is preferably 0.001 to 20 pats by mass and more preferably 0.01 to 15 pats by mass relative to 100 pats by mass of solvent (c) or polymerizable monomer (i-1). Water resistance of the resulting coated film is particularly favorable within these ranges and even when the amount of silane coupling agents (g) increases, there are no further great improvements in terms of performance.

The amount of colloidal silica (h) is preferably 0.001 to 100 pats by mass and more preferably 0.01 to 50 pats by mass relative to 100 pats by mass of solvent (c) or polymerizable monomer (i-1). Water resistance, weather resistance, and hardness greatly improve when the amount of colloidal silica (h) is 0.001 pats by mass or more.

Furthermore, it is possible to use the nanosubstance-containing composition of the present invention by adding various known substances therein such as plasticizing agents, dispersing agents, coating surface adjusting agents, fluidity adjusting agents, ultraviolet absorbers, antioxidants, preservation stabilizers, adhesion auxiliaries, and thickeners. Additionally, when nanocarbon materials (a-1), in particular, carbon nanotubes (a-2) are used as the nanosubstance (a), it is possible for the nanosubstance-containing composition of the present invention to contain conductive substances in order to further improve conductivity thereof. Examples of conductive substances include carbon-based substances such as carbon fibers, conductive carbon black, and graphite; metal oxides such as tin oxide and zinc oxide; metals such as silver, nickel, and copper; π-conjugated polymers, which contain repeating units of compounds such as phenylenevinylene, vinylene, thienylene, pyrrolylene, phenylene, iminophenylene, isothianaphthene, furylene, and carbazolylene; and symmetric or asymmetric indole-derivative trimers. Among these conductive substances, π-conjugated polymers, indole-derivative trimers, or their doped materials are more preferable and π-conjugated polymers, indole-derivative trimers, or their doped materials which have a sulfonic group and/or carboxylic group and which arm water soluble are particularly preferable.

### <Preparation Method of Nanosubstance-Containing Composition>

When mixing predetermined components, devices for agitating or kneading such as ultrasonic waves, homogenizer, spiral mixer, planetary mixer, disperser, hybrid mixer, or the like are used. In particular, it is preferable to mix carbon nanotubes (a-2), (meth)acrylic polymers (b), solvent (c) or polymerizable monomer (i-1), and other components and irradiate the mixture with ultrasonic waves and when this process is carried out, it is especially preferable to use ultrasonic wave-irradiation and homogenization concomitantly (using an ultrasonic homogenizer) for processing the mixture. Conditions for the treatment using ultrasonic wave-irradiation are not particularly limited as long as the intensity of ultrasonic waves and processing time which are sufficient for uniformly dispersing or dissolving nanosubstances in the solvent (c) or polymerizable monomer (i-1) are achieved. For example, the rated output in ultrasonic wave oscillators is preferably within the range of 0.1 to 2.0 W/cm² per unit area of the base thereof and more preferably 0.3 to 1.5 W/cm² and preferable oscillation frequency is within the range of 10 to 200 KHz and more preferably 20 to 100 KHz. In addition, time for ultrasonic wave irradiation treatment is preferably 1 minute to 48 hours and more preferably 5 minutes to 48 hours. It is desirable to further disperse or dissolve the nanosubstances thoroughly by using a ball-type kneading device such as a ball mill, vibration mill, sand mill, roil mill, or the like.

When mixing predetermined components, all the components may be added all at once or a concentrated solution/mixture of nanosubstance-containing composition using a small amount of solvent (c) or polymerizable monomer (i-1) used may be prepared in advance and thereafter the solution/mixture may be diluted to a predetermined concentration. In addition, when two or more types of solvents (c) or polymerizable monomers (i-1) are mixed for use, one or more components of solvents (c) or polymerizable monomers (i-1) may be used for preparing a concentrated solution/mixture of nanosubstance-containing composition in advance and thereafter other components of solvents (c) or polymerizable monomers (i-1) may be used for diluting the solution of nanosubstance-containing composition.

In addition, the temperature of the nanosubstance-containing composition at the time of carrying out ultrasonic wave-irradiation is preferably 60° C. or less and more preferably 40° C. or less in view of improvements in dispersibility. Particularly when preparing the nanosubstance-containing composition using polymerizable monomer (i-1), a temperature of 40° C. or less is preferable also from the viewpoint of polymerization inhibition.

### <Composite>

The composites of the present invention are those having a coated film or a cured film of the nanosubstance-containing composition of the present invention on a substrate surface.

Examples of substrates include films, sheets, foams, porous membranes, elastomers, and various molded articles which are made of synthetic resins; wood, paper materials, ceramics, fibers, nonwoven fabrics, carbon fibers, carbon fiber papers, glass plates, and stainless steel plates.

Examples of synthetic resins include polyethylene, polyvinylchloride, polypropylene, polystyrene, acrylonitrile-butadiene-styrene resin (ABS resin), acrylonitrile-styrene resin (AS resin), acrylic resin, methacrylic resin, polybutadiene, polycarbonate, polyarylate, polyvinylidene fluoride, polyester, polyamide, polyimide, polyaramid, polyphenylene sulfide, polyetheretherketone, polyphenylene ether, polyethemitrile, polyamideimide, polyethersulfone, polysulfone, polyethermide, polybutylene terephthalate, and polyurethane. Synthetic resins may be used singularly or in combination of two or more kinds.

The thickness of the coated film formed of the nanosubstance-containing composition, which is prepared using the solvent (c), is preferably within the range of 0.01 to 100 μm and more preferably within the range of 0.1 to 50 μm. The coated film maintains its transparency with the film thickness within this range and the coated film has sufficient conductivity especially when the nanosubstance (a) is a nanocarbon material (a-1) or a carbon nanotube (a-2).

The thickness of the cured film formed of the nanosubstance-containing composition, which is prepared using the polymerizable monomer (i-1), is preferably 0.5 μm or more and more preferably 1 μm or more in order to realize sufficient conductivity when the nanosubstance (a) is a nanocarbon material (a-1) or a carbon nanotube (a-2). In addition, the thickness of the cured film is preferably 100 μm or less and more preferably 50 μm or less in order to realize sufficient transparency and also to suppress deficiencies such as the occurrence of cracks in the cured film or the occurrence of chips in the cured film at the time of cutting the laminated body.

In the composites of the present invention, a reflection-preventing film may be provided on the coated film or the cured film where necessary. In addition, it is also possible to provide a cured film formed of the curable resin composition of the present invention on one surface of a substrate and to provide a thin film having other functions such as a reflection preventing-film, diffusion layer, and adhesion layer on the other surface of the substrate.

The composite of the present invention is excellent in transparency since the nanosubstance (a) is highly dispersed or dissolved in the coated film or cured film. For this reason, the total light transmittance of the laminated body of the present invention is 50% or more and preferably 70% or more, and thus the composite of the present invention can be applied to various usages such as transparent conductive films, transparent conductive sheets, and transparent conductive molded articles when the nanosubstance is a nanocarbon material or a carbon nanotube.

### <Composite Production Method>

When forming a coated film or curing film of the nanosubstance-containing composition of the present invention on the surface of a substrate, methods used in general coating processes can be adopted. For example, coating methods such as a gravure coater, roll coater curtain flow coater, spin coater, bar coater, reverse coater, kiss coater, fountain coater, rod coater, air doctor coater, knife coater, blade coater, cast coater, and screen coater; spraying methods such as spray coating using air spray, airless spray, or the like; and immersing methods such as dipping are used.

After the nanosubstance-containing composition, which is prepared by using the solvent (c), is coated on the substrate surface, the coated film may be left at room temperature or may be subjected to a heat treatment. This procedure can further reduce the amount of remaining solvent (c) and it is preferable when the nanosubstance (a) is a carbon nanotube (a-2) since the conductivity thereof further improves. The temperature for the heat treatment is preferably 20° C. or more and 250° C. or less and heating at 40° C. to 200° C. is particularly preferable. When the temperature is higher than 250° C., it is possible that the (meth)acrylic polymer (b) itself decomposes resulting in the deterioration of transparency and appearance thereof.

Examples of the methods to produce composites using the nanosubstance-containing composition, which is prepared using the polymerizable monomer (i-1), include the following methods: (i) method to coat the nanosubstance-containing composition onto a substrate to cure; (ii) method to coat the nanosubstance-containing composition onto the inner surface of a mold and cure the composition to form a cured film and thereafter, a polymerizable material or molten resin is casted into the mold and is solidified to form a substrate and the cured film is then separated from the mold together with the substrate; and (iii) method to cast the nanosubstance-containing composition between a mold and substrate and cure the composition to form a cured film and thereafter, separating the cured film together with the substrate from the mold.

Among these methods, the method (ii) is preferable since the cured film having favorable surface conditions can be achieved without the deterioration of the appearance thereof due to the influence of dust or the like.

Examples of the molds used in the method (ii) include molds for casting polymerization and dies for molding. When the mold is formed from two pieces of plate-like materials having a smooth surface, a plate-like laminate body, which has a smooth surface, can be obtained. When a laminated body is formed in such a manner, a cured film may be formed in one mold or may be formed in both molds.

As a substrate formation method, the so-called cast polymerization method where polymerizable material is injected into a mold for casting polymerization to polymerize is preferable.

Examples of the cast polymerization methods include a method to coat the nanosubstance-containing composition, which is prepared using a polymerizable monomer (i-1) and photopolymerization initiator (i-2), onto the inner surface of a glass mold for casting polymerization, which is formed from a glass plate, to photocure and thereafter, carrying out polymerization by casting a polymerizable material into the glass mold. The glass mold can be assembled by, for example, sandwiching a gasket formed from materials such as soft polyvinlylchloride, ethylene-vinyl acetate copolymer, polyethylene, and ethylene-methyl methacrylate copolymer between two glass plates and fixing them using a clamp or the like.

Examples of the continuous cast polymerization methods include a method to polymerize methyl methacrylate or the like between the two steel bands using an apparatus disclosed in Japanese Examined Patent Application, Second Publication No. S46-41602. In this continuous cast polymerization method, a cured film is formed by coating the nanosubstance-containing composition, which is prepared using the polymerizable monomer (i-1) and polymerization initiator (i-2) on the steel band surface to cure. In addition, by conferring designs such as uneven shapes on the steel band surface in advance, it is possible to produce composites having design properties on the surface thereof. Moreover, it is also possible to carry out the curing by pasting a film or the like which has uneven shapes on the surface thereof and which does not dissolve in the nanosubstance-containing composition or swell, and coat the nanosubstance-containing composition, which is prepared using the polymerizable monomer (i-1) and polymerization initiator (i-2), onto this uneven surface of the film.

In view of transparency of the laminated body having a cured film of curable resin composition, mixtures of monomers having (meth)acrylic acid or (meth)acrylate esters as major components or mixtures of a polymer where a part of this monomer mixture is polymerized and a monomer mixture are preferable as polymerizable materials.

Examples of (meth)acrylate esters include methyl (meth)acrylate, ethyl (meth)acrylate, propyl (meth)acrylate, butyl (meth)acrylate, n-hexyl (meth)acrylate, cyclohexyl (meth)acrylate, 2-ethylhexyl (meth)acrylate, phenyl (meth)acrylate, benzyl (meth)acrylate, dimethylaminoethyl (meth)acrylate, diethylaminoethyl (meth)acrylate, and ethyltrimethyl ammonium chloride (meth)acrylate.

The monomer mixture may contain other polymerizable monomers such as styrene, methylstrene, bromostyrene, vinyltoluene, divinylbenzene, vinyl acetate, N-vinylcaprolactam, and N-vinylpyrrolidone. Other polymerizable monomers may be used singularly or two or more kinds thereof may be combined for use.

The polymerization rate of monomers in the mixture of polymers, in which a part of the monomer mixture is polymerized, and monomer mixture is preferably 35% by mass or less.

It may be possible to add chain transfer agents to polymerizable materials. Mercaptan-based chain transfer agents having 2 to 20 carbon atoms such as alkylmercaptan, mercapto acid, thiophenol, and mixtures thereof, and those mercaptans having a short alkyl chain such as n-octylmercaptan and n-dodecylmercaptan are particularly preferable.

When polymerizing a polymerizable material by heating, radical polymerization initiators such as azo compounds, organic peroxides, and redox polymerization initiators may be added. Examples of azo compounds include 2,2′-azobisisobutyronitrile, 2,2′-azobis(2,4-dimethylvaleronitrile), and 2,2′-azobis(2,4-dimethyl-4-methoxyvaleronitrile). Examples of organic peroxides include benzoylperoxide and lauroylperoxide. Examples of redox polymerization initiators include combinations of organic peroxides and amines. When polymerizing a polymerizable material by ultraviolet-ray irradiation, photopolymerization initiators may be added Examples of commercially available photopolymerization initiators include “IRGACURE 184” (manufactured by Nihon Ciba-Geigy Co., Ltd.), “IRGACURE 907” (manufactured by Nihon Ciba-Geigy Co., Ltd) “DAROCUR 1173” (manufactured by Merck Ltd., Japan), and “EZACURE KIP100F” (manufactured by Nihon SiberHegner K.K.).

In addition, when polymerizing a polymerizable material by ultraviolet-ray irradiation, photosensitzers may be added. Examples of photosensitzers include benzoin, benzoinethyl ether, 2-hydroxy 2-methyl-1-phenyl propan-1-one, 1-hydroxycyclohexylphenyl ketone, azobisisobutyronitrile, and benzoylperoxide. Additionally, photosensitizers, which have sensitization action in a wavelength range of 400 nm or less, may be added.

Examples of methods to coat the nanosubstance-containing composition of the present invention on a mold include methods using a gravure coater, roll coater, curtain flow coater, spin coater, bar coater, reverse coater, kiss coater, fountain coater, rod coater, air doctor coater, knife coater, air knife coater, blade coater, cast coater, and screen coater; spraying methods such as spray coating using air spray, airless spray, or the like; and immersing methods such as dipping.

The nanosubstance-containing composition of the present invention described so far is capable of dispersing or dissolving the nanosubstance (a) in the solvent (c) or polymerizable monomer (i-1) without impairing the properties of the nanosubstance (a) itself and the nanosubstance (a) does not separate/aggregate even when preserved for a long time. Although the reason for this is not clearly elucidated, it is speculated that when the nanosubstance (a) is a carbon nanotube (a-2), carbon nanotube (a-2) disperses or dissolves in the solvent (c) or polymerizable monomer (i-1) together with the specific (meth)acrylic polymer (b) used in the present invention due to the (meth)acrylic polymer (b) adsorbing to or spirally wrapping the carbon nanotube (a-2).

In addition, in the laminated body of the present invention, since the cured film is formed while maintaining the state where the carbon nanotube (a-2) is highly dispersed or dissolved therein, detachment of the carbon nanotube (a-2) due to the external stimuli or the like does not occur and excellent conductivity and transparency can be maintained for a long time.

### EXAMPLES

The present invention will be described in detail using Examples. However, the Examples are not intended to limit the scope of the present invention. As a carbon nanotube of a raw material, a multilayer carbon nanotube formed by a gaseous phase flow method (floating catalyst method) manufactured by Nikkiso Co., Ltd. was used (hereinafter, a carbon nanotube may be referred to as CNT).

<Production of (meth)acrylic Polymer>

### Production Example 1

### Copolymer 1 of sodium 2-sulfoethyl methacrylate/potassium methacrylate/methyl methacrylate

150 g of sodium 2-sulfoethyl methacrylate, 25 g of potassium methacylate, 30 g of methyl methacrylate, and 2250 g of deionized water were poured into a 3000 ml (internal volume) separable flask equipped with a condenser. A temperature of the mixture was increased to 50° C. with stirring under a nitrogen atmosphere and further was increased to 60° C. after adding 0.2 g of 2,2′-azobis(2-methylpropionamidine) dihydrochloride as a polymerization initiator. Adding methyl methacrylate dropwise at the rate of 0.6 g/min was stared using a dropping pump when the polymerization initiator was added. Methyl metacrylate was continuously added dropwise for 75 minutes. The mixture was stirred for 6 hours at 60° C., as a result, a transparent polymer solution was obtained. The solution remained homogeneous during polymerization, and a suspended condition of oil droplets of methyl methacrylate was not observed. An aqueous solution of (meth)acrylic polymer (1) having a solid content of 8.4% was obtained.

### Production Example 2

### Copolymer 2 of sodium 2-sulfoethyl methacrylate/potassium methacrylate/methyl methacrylate

20 g of sodium 2-sulfoethyl methacrylate, 10 g of potassium methacrylate, 170 g of methyl methacrylate, 350 g of tetrahydrofuran, 350 g of methanol, and 100 g of deionized water were poured into a 2000 ml (internal volume) separable flask equipped with a condenser and stirred under a nitrogen atmosphere. A temperature of the mixture was increased to 60° C. after adding 1.5 g of 2,2′-azobis(2,4-dimethylvaleronitrile) as a polymerization initiator. The mixture was stirred for 6 hours, as a result, a transparent polymer solution was obtained. The solution remained homogeneous during polymerization, and precipitation and sedimentation of the polymer and emulsion of the polymer solution were not observed. The polymer solution was cooled at room temperature, and then was reprecipitated with isopropanol to collect a white powder. The white powder was dried at 40° C. in a vacuum dryer to obtain a (meth)acrylic polymer (2).

### Comparative Production Example 1

### Dimethylaminomethyl polymethacrylate

15 g of dimethylaminomethyl methacrylate and 35 g of methanol were poured into a 200 ml (internal volume) separable flask equipped with a condenser and stirred under a nitrogen atmosphere. A temperature of the mixture was increased to 55° C. after adding 0.075 g of 2,2′-azobis(2,4-dimethylvalemronitrile) as a polymerization initiator. The mixture was stirred for 6 hours, as a result, a transparent polymer solution was obtained. The polymer solution was cooled at room temperature, and then was reprecipitated with water to collect a white powder. The white powder was dried at 40° C. in a vacuum dryer to obtain dimethylaminomethyl polymethacrylate.

### <Production of Amine Compound>

### Production Example 3

### Copolymer of dimethylaminopropyl methacrylamide/polyethylene glycol (23) monomethacrylate monomethylether

188 g of dimethylaminopropyl methacrylamide and 228 g of methanol were poured into a glass flask equipped with a stirring blade. A mixture of 136 g of dimethyl sulfate and 41.3 g of methanol was added dropwise into the flask so as to be 15° C. or lower therein. The mixture was stirred for 30 minutes after adding to obtain 593.3 g of a solution containing 318 g of dimethylaminopropyl methacrylamide quaternized by dimethyl sulfate.

2.48 g of 2,2-azobis(2,4-valeronitrile), 2.48 g of n-octylmercaptan, 406 g of methanol, 485 g of polyethylene glycol (23) monomethacrylate monomethylether (“23” is a number of polyethylene glycol units), and 16.5 g of 4-methacryloxy-2,2,6,6-tetramethylpiperidine were added to the solution. The mixture was polymerize under nitrogen atmosphere over 6 hours at 60° C., and then, was vacuum-dried for 3 days at 50° C. to obtain an amine compound.

### Preparation of Polymeric Monomer>

### Preparation Example 1

50 g of dipentaerythritol hexaacrylate (trade name: KAYARAD DPHA, manufactured by Nippon Kayaku, Co., Ltd.), 40 g of 1,6-hexanediol diacrylate (manufactured by Osaka Organic Chemical Industry Ltd.), and 10 g of 2-hydroxyethyl acrylate (trade name: HEA, manufactured by Osaka Organic Chemical Industry Ltd.) were mixed to prepare a polymeric monomer (1).

### Preparation Example 2

40 g of depentaerythritol hexaacrylate (trade name: KAYARAD DPHA, manufactured by Nippon Kayaku, Co., Ltd.), 50 g of 2,6-hexanediol diacrylate (manufactured by Osaka Organic Chemical Industry Ltd.), and 10 g of 2-hydroxyethyl acrylate (trade name: HEA, manufactured by Osaka Organic Chemical Industry Ltd.) were mixed to prepare a polymeric monomer (2).

### Example 1

### Nanosubstance Containing Composition 1

The (meth)acrylic polymer (1) aqueous solution containing polar groups of the above-described Production Example 1 was diluted with water to prepare a solution of 5 parts by mass of (meth)acrylic polymer and 100 parts by mass of water. 0.1 parts by mass of carbon nanotube was mixed to the solution at room temperature and an ultrasonic homogenizing treatment was carried out to the mixture by an ultrasonic homogenizer (trade name: VIBRA-CELL (20 kHz), manufactured by Sonics and Materials, Inc.) for one hour to obtain a nanosubstance-containing composition 1.

### Example 2

### Nanosubstance-Containing Composition 2

Except for 1 part by mass of (meth)acrylic polymer, a sample was prepared by the same process as described in Example 1 to obtain a nanosubstance-containing composition 2.

### Example 3

### Nanosubstance-Containing Composition 3

Except for 0.05 parts by mass of carbon nanotube, a sample was prepared by the same process as described in Example 2 to obtain a nanosubstance-containing composition 3.

### Example 4

### Nanosubstance-Containing Composition 4

5 parts by mass of the (meth)acrylic polymer (2) containing polar groups of the above-described Production Example 2 and 100 parts by mass of methanol, and 0.1 parts by mass of carbon nanotube were mixed at room temperature and an ultrasonic homogenizing treatment was carried out to the mixture by an ultrasonic homogenizer (trade name. VIBRA-CELL (20 kHz), manufactured by Sonics and Materials, Inc.) for one hour to obtain a nanosubstance-containing composition 4.

### Example 5

### Nanosubstance-Containing Composition 5

Except for 1 part by mass of (meth)acrylic polymer (2), a sample was prepared by the same process as described in Example 4 to obtain a nanosubstance-containing composition 5.

### Example 6

### Nanosubstance-Containing Composition 6

Except for 0.05 parts by mass of carbon nanotube, a sample was prepared by the same process as described in Example 5 to obtain a nanosubstance-containing composition 6.

### Example 7

### Nanosubstance-Containing Composition 7

Except for further adding 16 parts by mass of amine compound of the above-described Production Example 3, a sample was prepared by the same process as described in Example 1 to obtain a nanosubstance-containing composition 7.

### Example 8

### Nanosubstance-Containing Composition 8

Except for further adding 1 part by mass of PVP K-15 (manufactured by Gokyo Trading Co., Ltd.) as a polymer compound, a sample was prepared by the same process as described in Example 1 to obtain a nanosubstance-containing composition 8.

### Example 9

### Nanosubstance-Containing Composition 9

Except for further adding 0.1 parts by mass of sodium dodecylbenzene sulfonate as a surfactant, a sample was prepared by the same process as described in Example 1 to obtain a nanosubstance-containing composition 9.

### Example 10

### Nanosubstance-Containing Composition 10

Polyacrylic amide 2-methylpropane sulfonic acid 15% aqueous solution (hereinafter, may be referred to PAMPS) (manufactured by Sigma-Aldrich Corporation) was diluted with water to prepare a solution of 5 parts by mass of PAMPS and 100 parts by mass of water. 0.05 parts by mass of carbon nanotube was mixed to the solution at room temperature and an ultrasonic homogenizing treatment was carried out to the mixture for one hour to obtain a nanosubstance-containing composition 11.

### Example 11

### Nanosubstance-Containing Composition 11

A copolymer of acrylamide 2-methylpropane sulfonic acid/acrylonitrile (hereinafter, may be referred to P(AMPS/AN)) (manufactured by Sigma-Aldrich Corporation) was diluted with dimethylacetamide (may be referred to DMAC) to prepare a solution of 5 parts by mass of P(AMPS/AN) and 100 parts by mass of DMAC 0.1 parts by mass of carbon nanotube was mixed to the solution at room temperature and an ultrasonic homogenizing treatment was carried out to the mixture for one hour to obtain a nanosubstance-containing composition 11.

Compositions of nanosubstance-containing compositions of Examples 1 to 11 are shown in the following Table 1.

TABLE 1

| | | | | Amine | Polymer | |
|---|---|---|---|---|---|---|
| | Nanosubstance | | Solvent/Polymeric | compound | compound | Surfactant |
| | (parts by | Dispersing agent | monomer | (parts by | (parts by | (parts by |
| | mass) | (parts by mass) | (parts by mass) | mass) | mass) | mass) |
| Ex. 1 | CNT: 0.1 | (Meth)acrylic | Water: 100 | — | — | — |
| | | polymer (1): 5 | | | | |
| Ex. 2 | CNT: 0.1 | (Meth)acrylic | Water: 100 | — | — | — |
| | | polymer (1): 1 | | | | |
| Ex. 3 | CNT: 0.05 | (Meth)acrylic | Water: 100 | — | — | — |
| | | polymer (1): 1 | | | | |
| Ex. 4 | CNT: 0.1 | (Meth)acrylic | Methanol: 100 | — | — | — |
| | | polymer (2): 5 | | | | |
| Ex. 5 | CNT: 0.1 | (Meth)acrylic | Methanol: 100 | — | — | — |
| | | polymer (2): 1 | | | | |
| Ex. 6 | CNT: 0.05 | (Meth)acrylic | Methanol: 100 | — | — | — |
| | | polymer (2): 1 | | | | |
| Ex. 7 | CNT: 0.1 | (Meth)acrylic | Water: 100 | 16 | — | — |
| | | polymer (1): 5 | | | | |
| Ex. 8 | CNT: 0.1 | (Meth)acrylic | Water: 100 | — | PVP: 1 | — |
| | | polymer (1): 5 | | | | |
| Ex. 9 | CNT: 0.1 | (Meth)acrylic | Water: 100 | — | — | DBS: 0.1 |
| | | polymer (1): 5 | | | | |
| Ex. 10 | CNT: 0.05 | PAMPS: 5 | Water: 100 | — | — | — |
| Ex. 11 | CNT: 0.1 | P(AMPS/AN): 5 | DMAC: 100 | — | — | — |

### Example 12

### Nanosubstance-Containing Composition 12

5 parts by mass of the (meth)acrylic polymer (2) of the above-described Production Example 2 and 0.05 parts by mass of carbon nanotube were added to 100 parts by mass of the polymeric monomer (1) of the above-described Preparation Example 1 and were mixed at room temperature. An ultrasonic homogenizing treatment was carried out to the mixture by an ultrasonic homogenizer (trade name: VIBRA-CELL (20 kHZ), manufactured by Sonics and Materials, Inc.) for one hour and then, 1.5 parts by mass of benzoin isopropyl ether (trade name: SEIKUOL BIP, manufactured by Seiko Chemical Co., Ltd., hereinafter, may be referred to BIP) was added to the mixture as an optical polymerization initiator to obtain a nanosubstance-containing composition 12.

### Example 13

### Nanosubstance-Containing Composition 13

Except for further adding 16 parts by mass of mine compound of the above-described Production Example 3, a sample was prepared by the same process as described in example 12 to obtain a nanosubstance-containing composition 11.

### Example 14

### Nanosubstance-Containing Composition 14

Except for 0.1 parts by mass of carbon nanotube, a sample was prepared by the same process as described in Example 13 to obtain a nanosubstance-containing composition 14.

### Example 15

### Nanosubstance-Containing Composition 15

1 part by mass of the (meth)acrylic polymer (2) of the above-described Production Example 2, 0.05 parts by mass of carbon nanotube, and 8 parts by mass of the amine compound of the above-described Production Example 3 were added to 100 parts by mass of the polymeric monomer (2) of the above-described Preparation Example 1 and were mixed at room temperature. A homogenizing treatment was carried out to the mixture by an ultrasonic homogenizer (trade name: VIBRA-CELL (20 kHz), manufactured by Sonics and Materials, Inc.) for one hour and then, 1.5 parts by mass of BIP was added to the mixture as an optical polymerization initiator to obtain a nanosubstance-containing composition 15.

### Example 16

### Nanosubstance-Containing Composition 16

Except for further adding 10 parts by mass of methanol, a sample was prepared by the same process as described in Example 13 to obtain a nanosubstance-containing composition 16.

Compositions of nanosubstance-containing compositions of Examples 12 to 16 are shown in the following Table 2.

TABLE 2

| | | | | Amine | Polymerization |
|---|---|---|---|---|---|
| | | Dispersing | Solvent/Polymeric | compound | initiator |
| | Nanosubstance | agent | monomer | (parts by | (parts by |
| | (parts by mass) | (parts by mass) | (parts by mass) | mass) | mass) |
| Ex. 12 | CNT: 0.05 | (Meth)acrylic | Polymeric | — | BIP: 1.5 |
| | | polymer (2): 5 | monomer (1): 100 | | |
| Ex. 13 | CNT: 0.05 | (Meth)acrylic | Polymeric | 16 | BIP: 1.5 |
| | | polymer (2): 5 | monomer (1): 100 | | |
| Ex. 14 | CNT: 0.1 | (Meth)acrylic | Polymeric | 16 | BIP: 1.5 |
| | | polymer (2): 5 | monomer (1): 100 | | |
| Ex. 15 | CNT: 0.05 | (Meth)acrylic | Polymeric | 8 | BIP: 1.5 |
| | | polymer (2): 1 | monomer (2): 100 | | |
| Ex. 16 | CNT: 0.1 | (Meth)acrylic | Polymeric | 16 | BIP: 1.5 |
| | | polymer (2): 1 | monomer (2): 100 | | |
| | | | Methanol: 10 | | |

### Comparative Example 1

### Nanosubstance-Containing Composition 17

Except for excluding the (meth)acrylic polymer (1) of Example 1, a sample was prepared by the same process as described in Example 1 to obtain a nanosubstance-containing composition 17.

### Comparative Example 2

### Nanosubstance-Containing Composition 18

Except for 0.05 parts by mass of carbon nanotube, a sample was prepared by the same process as described in Comparative Example 1 to obtain a nanosubstance-containing composition 18.

### Comparative Example 3

### Nanosubstance-Containing Composition 19

Except for adding 1 part by mass of sodium dodecylbenzene sulfonate as a surfactant, a sample was prepared by the same process as described in Comparative Example 1 to obtain a nanosubstance-containing composition 19.

### Comparative Example 4

### Nanosubstance-Containing Composition 20

Except for 5 parts by mass of sodium dodecylbenzene sulfonate, a sample was prepared by the same process as described in Comparative Example 3 to obtain a nanosubstance-containing composition 20.

### Comparative Example 5

### Nanosubstance-Containing Composition 21

Except for replacing 5 parts by mass of polyaniline sulfonic acid for the (meth)acrylic polymer (1), a sample was prepared by the same process as described in Example 1 to obtain a nanosubstance-containing composition 21.

### Comparative Example 6

### Nanosubstance-Containing Composition 22

Except for replacing 5 parts by mass of sodium polystyrene sulfonate for the (meth)acrylic polymer (1), a sample was prepared by the same process as described in Example 1 to obtain a nanosubstance-containing composition 22.

### Comparative Example 7

### Nanosubstance-Containing Composition 23

Except for replacing 5 parts by mass of DEMOL N (manufactured by Kao Corporation) for the (meth)acrylic polymer (1), a sample was prepared by the same process as described in Example 1 to obtain a nanosubstance-containing composition 23.

### Comparative Example 8

### Nanosubstance-Containing Composition 24

Except for replacing 1 part by mass of DEMOL N (manufactured by Kao Corporation) for the (meth)acrylic polymer (1), a sample was prepared by the same process as described in Example 1 to obtain a nanosubstance-containing composition 24.

### Comparative Example 9

### Nanosubstance-Containing Composition 25

Except for replacing 5 parts by mass of PVP K-15 (manufactured by Gokyo Trading Co., Ltd.) for the (meth)acrylic polymer (1), a sample was prepared by the same process as described in Example 1 to obtain a nanosubstance-containing composition 25.

### Comparative Example 10

### Nanosubstance-Containing Composition 26

Except for replacing 1 part by mass of PVP K-15 (manufactured by Gokyo Trading Co., Ltd.) for the (meth)acrylic polymer (1), a sample was prepared by the same process as described in Example 1 to obtain a nanosubstance-containing composition 26.

### Comparative Example 11

### Nanosubstance-Containing Composition 27

Except for replacing 5 parts by mass of dimethylaminomethyl polymethacrylate of Comparative Production Example 1 for the (meth)acrylic polymer (2) of Example 4, a sample was prepared by the same process as described in Example 4 to obtain a nanosubstance-containing composition 27.

Compositions of nanosubstance-containing compositions of Comparative Examples 1 to 11 are shown in the following Table 3.

TABLE 3

| | Nanosubstance | Dispersing agent | Solvent | Surfactant |
|---|---|---|---|---|
| | (parts by mass) | (parts by mass) | (parts by mass) | (parts by mass) |
| Comp. Ex. 1 | CNT: 0.1 | — | Water: 100 | — |
| Comp. Ex. 2 | CNT: 0.05 | — | Water: 100 | — |
| Comp. Ex. 3 | CNT: 0.1 | — | Water: 100 | DBS: 1 |
| Comp. Ex. 4 | CNT: 0.1 | — | Water: 100 | DBS: 5 |
| Comp. Ex. 5 | CNT: 0.1 | Polyaniline sulfonic | Water: 100 | — |
| | | acid: 5 | | |
| Comp. Ex. 6 | CNT: 0.1 | Polystyrene sulfonic | Water: 100 | — |
| | | acid: 5 | | |
| Comp. Ex. 7 | CNT: 0.1 | DEMOL N: 1 | Water: 100 | — |
| Comp. Ex. 8 | CNT: 0.1 | DEMOL N: 1 | Water: 100 | — |
| Comp. Ex. 9 | CNT: 0.1 | PVP K-15: 1 | Water: 100 | — |
| Comp. Ex. 10 | CNT: 0.1 | PVP K-15: 5 | Water: 100 | — |
| Comp. Ex. 11 | CNT: 0.1 | Dimethylaminomethyl | Methanol: 100 | — |
| | | polymethacrylate: 5 | | |

DEMOL N (manufactured by Kao Corporation) and PVP K-15 (manufactured by Gokyo Trading Co., Ltd) are shown in the following Table 4.

TABLE 4

| | Composition | Constitutional formula |
|---|---|---|
| DEMOL N | Sodium salt ofβ-naphthalenesulfonic acidformalincondensationproduct | 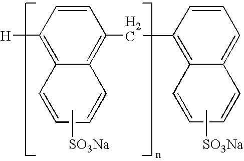 |
| PVP K-15 | Polyvinyl-pyrrolidone | 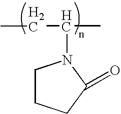 |

### Comparative Example 12

### Nanosubstance-Containing Composition 28

Except for excluding the (meth)acrylic polymer (2), a sample was prepared by the same process as described in Example 10 to obtain a nanosubstance-containing composition 28.

### Comparative Example 13

### Nanosubstance-Containing Composition 29

Except for replacing 5 parts by mass of DEMOL N (manufactured by Kao Corporation) for the (meth)acrylic polymer (2), a sample was prepared by the same process as described in Example 10 to obtain a nanosubstance-containing composition 29.

### Comparative Example 14

### Nanosubstance-Containing Composition 30

Except for replacing 5 parts by mass of PVP K-15 (manufactured by Gokyo Trading Co., Ltd) for the (meth)acrylic polymer (2), a sample was prepared by the same process as described in Example 10 to obtain a nanosubstance-containing composition 30.

Compositions of nanosubstance-containing compositions of Comparative Examples 12 to 14 are shown in the following Table 5.

TABLE 5

| | Nanosubstance | Dispersing | Solvent | Polymerization |
|---|---|---|---|---|
| | (parts by | agent (parts | (parts by | initiator |
| | mass) | by mass) | mass) | (parts by mass) |
| Comp. Ex. | CNT: 0.05 | — | Polymeric | BIP: 1.5 |
| 12 | | | monomer | |
| | | | (1): 100 | |
| Comp. Ex. | CNT: 0.05 | DEMOL | Polymeric | BIP: 1.5 |
| 13 | | N: 5 | monomer | |
| | | | (1): 100 | |
| Comp. Ex. | CNT: 0.05 | PVP | Polymeric | BIP: 1.5 |
| 14 | | K-15: 5 | monomer | |
| | | | (1): 100 | |

### <Evaluation Method>

### (Visual Observation of Solution Condition)

Solution conditions of nanosubstance-containing composition obtained by examples and comparative examples were visually observed just after dispersion treatment and after settling for one day.

A: visually homogeneous composition in solution condition
B: visually non-homogeneous composition in solution condition

### (Evaluation of Composite)

### Example 1 (Nanosubstance-Containing Composition 1) to Example 11

### (Nanosubstance-Containing Composition 11) and Comparative Example 1

### (Nanosubstance-Containing Composition 17) to Comparative Example 11

### (Nanosubstance-Containing Composition 27)

The composition was applied to a glass plate by a bar coater method (using bar coat No. 3) and the applied composition was dried for 5 minutes at 80° C. to form a composite. The appearance of the composite was observed, and subsequently, total light transmittance and surface resistance thereof were measured.

### Example 12 (Nanosubstance-Containing Composition 12), Example 13

### (Nanosubstance-Containing Composition 13), Example 16 (Nanosubstance-Containing Composition 16), and Comparative Example 12 (Nanosubstance-Containing Composition 28) to Comparative Example 14 (Nanosubstance-Containing Composition 30)

The composition was dropped on an acryl resin plate (3 mm thickness), a polyethylene terephthalate film (hereinafter, may be referred to PET film) having 50 μm thickness (manufactured by Teijin Ltd.) was provided thereon to prepare a layer. The layer was pressed with a rubber roll having JIS hardness of 30° to set the thickness of the composition to 30 μm. Subsequently, the layer was passed below a fluorescent UV lamp (power 40W) (FL40BL, manufactured by Toshiba Corporation) while maintaining the distance between the layer and the lamp of 10 cm at a rate of 0.8 m/min, in which the PET film surface was directly irradiated, to precure the composition. Subsequently, the PET film was peeled from the layer. Subsequently, the layer was passed below a high pressure mercury lamp (power 30W) while maintaining a distance between the layer and the lamp of 20 cm at a rate of 0.8 m/min, in which the composition was directly irradiated, to cure the composition. As a result, a composite on which a cured film was provided was obtained. The appearance of the obtained composite was observed, and subsequently, total light transmittance and surface resistance thereof were measured.

### Example 14 (Nanosubstance-Containing Composition 14) and Example 15 (Nanosubstance-Containing Composition 15)

The composition was dropped on a mirror surface side of a stainless plate having the mirror surface, a biaxially oriented film made of PET having 50 μm thickness (manufactured by Teijin Ltd.) was provided thereon to prepare a layer. The layer was pressed with a rubber roll having JIS hardness of 30° to set the thickness of the composition 30 μm. Subsequently, the layer was passed below a fluorescent UV lamp (power 40W) (FL40BL, manufactured by Toshiba Corporation) while maintaining the distance between the layer and the lamp of 10 cm at a rate of 0.8 m/min, in which the PET film surface was directly irradiated, to precure the composition. Subsequently, the PET film was peeled from the layer. Subsequently, the layer was passed below a high pressure mercury lamp (power 30W) while maintaining a distance between the layer and the lamp of 20 cm at a rate of 0.8 m/min, in which the composition was directly irradiated, to cure the composition. As a result, a cured film was formed. Two stainless plates on which cured films were formed were superposed so that the cured films were inside, and sealed around the superposed plates with a gasket made of soft polyvinyl chloride resin to prepare a casting mold. A polymeric raw material composed of 100 parts by mass of methyl methacrylate in which a rate of polymerization is 20 parts by mass and 0.05 parts by mass of 2,2-azobis(2,4 dimethylvaleronitrile) was injected to the casting mold and was polymerized in water at 80° C. for one hour, and subsequently, was polymerized in an air furnace at 130° C. for one hour while the distance between two stainless plates was adjusted to 2 mm. The resulting product was cooled and then a resin plate was peeled from the stainless steel plates to obtain a composite on which a cured film was provided. The appearance of the obtained composite was observed, and subsequently total light transmittance and surface resistance thereof were measured.

### (Surface Resistance)

Surface resistances were measured at 25° C. and 15% RH. When the surface resistance was 108Ω or greater, a two-point probe method (distance between two electrodes: 20 mm) was used. When the surface resistance was 107Ω or less, a four-point probe method (distance between electrodes: 5 mm) was used.

### (Total Light Transmittance)

Total light transmittance (%) was measured by HAZEMETER NDH2000 manufactured by Nippon Denshoku Industries, Co., Ltd.

### (Observation of Appearance of Composite)

Film formability, surface homogeneity, and color tone of the composite obtained by coating were visually observed.

### (Film Formability)

A: Homogeneous coated film was easily formed.
B: Coated film was not formed.

### (Homogeneity)

A: Homogeneous composite in which aggregate was not observed on the surface thereof.
B: Non-homogeneous composite in which carbon nanotube was aggregated on the surface thereof.

Evaluation results of nanosubstance-containing compositions and coated films of Examples 1 to 11 are shown in the following Table 6, and those of Comparative Examples 1 to 11 are shown in the following Table 7.

TABLE 6

| | | Solution | | Total | | | | |
|---|---|---|---|---|---|---|---|---|
| | | condition | Surface | light | Appearance of coated film | | | |
| | Solution | (one day | resistance | transmittance | Film | | | |
| | condition | after) | (Ω) | (%) | formability | Homogeneity | Color tone | Remark |
| Ex. 1 | A | A | 6.5 × 10⁶ | 80 | A | A | Colorless | |
| Ex. 2 | A | A | 3.2 × 10⁶ | 82 | A | A | Colorless | |
| Ex. 3 | A | A | 1.3 × 10⁹ | 90 | A | A | Colorless | |
| Ex. 4 | A | A | 2.5 × 10⁹ | 87 | A | A | Colorless | |
| Ex. 5 | A | A | 2.7 × 10⁶ | 88 | A | A | Colorless | |
| Ex. 6 | A | A | 4.8 × 10¹³ | 90 | A | A | Colorless | |
| Ex. 7 | A | A | 2.9 × 10⁸ | 90 | A | A | Colorless | |
| Ex. 8 | A | A | 8.0 × 10⁷ | 87 | A | A | Colorless | |
| Ex. 9 | A | A | 1.8 × 10⁸ | 92 | A | A | Colorless | |
| Ex. 10 | A | A | 2.3 × 10⁶ | 85 | A | A | Colorless | |
| Ex. 11 | A | A | 1.7 × 10¹¹ | 86 | A | A | Colorless | |

TABLE 7

| | | Solution | | Total | | | | |
|---|---|---|---|---|---|---|---|---|
| | | condition | Surface | light | Appearance of coated film | | | |
| | Solution | (one day | resistance | transmittance | Film | | | |
| | condition | after) | (Ω) | (%) | formability | Homogeneity | Color tone | Remark |
| Comp. | B | B | (*1) | (*1) | B | — | — | Film was not |
| Ex. 1 | | | | | | | | formed |
| Comp. | A | A | (*1) | (*1) | B | — | — | Film was not |
| Ex. 3 | | | | | | | | formed |
| Comp. | A | A | (*1) | (*1) | B | — | — | Film was not |
| Ex. 4 | | | | | | | | formed |
| Comp. | A | A | 3.8 × 10⁶ | 72 | A | A | Yellow | Colored by |
| Ex. 5 | | | | | | | | dispersing |
| | | | | | | | | agent |
| Comp. | A | A | 1.5 × 10¹³ | 58 | A | B | Black | Aggregate of |
| Ex. 6 | | | | | | | Nonuniformity | CNT |
| Comp. | A | B | 3.5 × 10⁹ | 78 | A | B | Black | Aggregate of |
| Ex. 7 | | | | | | | Nonuniformity | CNT |
| Comp. | A | B | 4.3 × 10¹⁰ | 80 | A | B | Black | Aggregate of |
| Ex. 8 | | | | | | | Nonuniformity | CNT |
| Comp. | B | B | >1.0 × 10¹⁴ | 57 | A | B | Black | Aggregate of |
| Ex. 9 | | | | | | | Nonuniformity | CNT |
| Comp. | B | B | >1.0 × 10¹⁴ | 68 | A | B | Black | Aggregate of |
| Ex. 10 | | | | | | | Nonuniformity | CNT |
| Comp. | B | B | >1.0 × 10¹⁴ | 55 | B | B | Black | Aggregate of |
| Ex. 11 | | | | | | | Nonuniformity | CNT |

(*1): Due to defect of film formability, surface resistance and total light transmittance thereof could not be measured.

Evaluation results of nanosubstance-containing compositions and laminated bodies of examples 12 to 16 and comparative examples 12 to 14 are shown in the following Table 8.

TABLE 8

| | | Solution | | Total | | | | |
|---|---|---|---|---|---|---|---|---|
| | | condition | Surface | light | Appearance of laminated body | | | |
| | Solution | (one day | resistance | transmittance | Film | | Color | |
| | condition | after) | (Ω) | (%) | formability | Homogeneity | tone | Remark |
| Ex. 12 | A | A | 1.5 × 10⁸ | 89 | A | A | Colorless | |
| Ex. 13 | A | A | 1.3 × 10⁹ | 90 | A | A | Colorless | |
| Ex. 14 | A | A | 4.3 × 10⁷ | 81 | A | A | Colorless | |
| Ex. 15 | A | A | 4.4 × 10¹⁰ | 90 | A | A | Colorless | |
| Ex. 16 | A | A | 2.5 × 10⁸ | 82 | A | A | Colorless | |
| Comp. | B | B | >1.0 × 10¹⁴ | (*1) | A | B | | (*3) |
| Ex. 12 | | | | | | | | |
| Comp. | A | B | 2.7 × 10¹¹ (*2) | 70 | A | B | Black | Aggregate |
| Ex. 13 | | | | | | | Nonuniformity | of CNT |
| Comp. | A | B | >1.0 × 10¹⁴ | (*1) | A | B | | (*3) |
| Ex. 14 | | | | | | | | |

(*1): Total light transmittance was not measured because CNT was not dispersed and thereby, CNT was removed when film formation was carried out by pressing with a rubber roll.
(*2): Dispersion with measuring points was large.
(*3): Coated films containing no CNT because aggregated CNT was removed when film formation was carried out by pressing with a rubber roll.

### Industrial Applicability

A nanosubstance-containing composition of the present invention can be applied for various antistatic agents, condensers, electric double layer capacitors, cells, fuel cells and polymer electrolyte films thereof, electrode layers, catalyst layers, gas diffusion layers, gas diffusion electrode layers, members such as a separator, EMI shields, chemical sensors, display devices, nonlinear materials, anticorrosives, adhesives, fibers, spinning materials, antistatic coating, anticorrosive coating, electrodeposition coating, plating primers, conductive primers for electrostatic coating, electric anticorrosion, and improvement of condensed capacity of a cell by using simple methods such as coating, spraying, casting and dipping. Furthermore, a composite of the present invention can be used as an industrial packaging material for semiconductors, and electrical and electronic parts, a transparent conductive resin plate used in a clean room when semiconductors are manufactured, a film for an overhead projector, an antistatic film for electrophotograph recording materials such as slide films, a transparent conductive film, an audio tape, a video tape, a tape for a computer, an antistatic material for magnetic recording tapes such as diskettes, an LSI wiring of electronic devices, an electron gun (electron source) and electrode of a field emission display (FED), and a hydrogen storage agent, and further, a display protection plate of a surface of input or display device of a flat panel display such as a transparent touch panel, an electro luminescence display, and a liquid crystal display, a front plate, an antic agent and a transparent electrode, a transparent electrode film, a luminescent material forming an organic electro luminescence device, a buffer material, an electron transporting material, a hole transporting material, a fluorescent material, a thermal transfer sheet, a transfer sheet, a thermal transfer receiving sheet, and a receiving sheet.

What is claimed is:

1. A nanosubstance-containing composition comprising: a nanosubstance (a); a (meth)acrylic polymer (b) having a unit derived from a (meth)acrylic monomer expressed by the following formula (I); and a solvent (c), 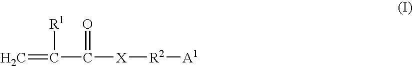
wherein R¹ represents a hydrogen atom or a methyl group, X represents —O—, —NH—, or —N(CH₃)—, R² represents an alkylene group having a number of carbon atoms of 1-24, an arylene group having a number of carbon atoms of 1-24, or an aralkylene group having a number of carbon atoms of 1-24, and A¹ represents one selected from the group consisting of a carboxyl group, carboxylate group, sulfonic acid group, sulfonate group, phosphonic acid group, and phosphonate group.

2. A nanosubstance-containing composition according to claim 1, further comprising an amine compound (d).

3. A nanosubstance-containing composition comprising: a nanosubstance (a); a (meth)acrylic polymer (b) having a unit derived from a (meth)acrylic monomer expressed by the following formula (I); and a polymerizable monomer (i-1), 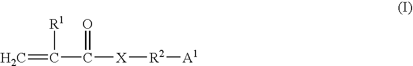
wherein R¹ represents a hydrogen atom or a methyl group, X represents —O—, —NH—, or —N(CH₃)—, R² represents an alkylene group having a number of carbon atoms of 1-24, an arylene group having a number of carbon atoms of 1-24, or an aralkylene group having a number of carbon atoms of 1-24, and A¹ represents one selected from the group consisting of a carboxyl group, carboxylate group, sulfonic acid group, sulfonate group, phosphonic acid group, and phosphonate group.

4. A nanosubstance-containing composition according to claim 3, further comprising a polymerization initiator (i-2).

5. A nanosubstance-containing composition according to claim 3, further comprising an amine compound (d).

6. A method for preparing the nanosubstance-containing composition of claim 1, comprising: mixing a nanosubstance (a), a (meth)acrylic polymer (b), and a solvent (c); and irradiating ultrasonic waves to the mixture.

7. A method for preparing the nanosubstance-containing composition of claim 3, comprising: mixing a nanosubstance (a), a (meth)acrylic polymer (b), and a polymerizable monomer (i-1); and irradiating ultrasonic waves to the mixture.

8. A method for preparing a composite, comprising: applying the nanosubstance-containing composition of claim 1 to at least one surface of a substrate; and forming a coated film or a cured film by leaving at room temperature, subjecting to a heating process and/or irradiating light.

9. A method for preparing a composite, comprising: applying the nanosubstance-containing composition of claim 3 to at least one surface of a substrate; and forming a coated film or a cured film by leaving at room temperature, subjecting to a heating process and/or irradiating light.

10. A method for preparing a composite, comprising: forming a cured film by applying the nanosubstance-containing composition of claim 3 to an inner surface of a mold and curing the nanosubstance-containing composition; introducing a polymerizable material or a molten resin into the mold and solidifying it to be a substrate; and separating the substrate together with the cured film from the mold.

11. A composite comprising a coated film or a cured film which is formed by applying the nanosubstance-containing composition of claim 1 to at least one surface of a substrate; and leaving at room temperature, subjecting to a heating process and/or irradiating light.

12. A composite comprising a coated film or a cured film which is formed by applying the nanosubstance-containing composition of claim 3 to at least one surface of a substrate; and leaving at room temperature, subjecting to a heating process and/or irradiating light.

13. A composite produced by: forming a cured film by applying the nanosubstance-containing composition of claim 3 to inner surface of a mold and curing the composition; introducing a polymerizable material or a molten resin into the mold and solidifying the material or the resin to be a substrate; and separating the substrate together with the cured film from the mold.

14. A composite according to any one of claims 11 to 13, wherein an total light transmittance of the composite is 50% or greater.

15. A composite according to any one of claims 11 to 13, wherein the composite is a transparent conductive film, a transparent conductive sheet, or a transparent conductive molded article.
